(19) United States
(12) Patent Application Publication
(10) Pub. No.: US 2025/0011582 A1
(43) Pub. Date: Jan. 9, 2025

(54) LATENT CURING AGENT, PRODUCTION METHOD THEREFOR, AND CURABLE COMPOSITION

(71) Applicant: DEXERIALS CORPORATION, Tochigi (JP)

(72) Inventor: Kazunobu KAMIYA, Tochigi (JP)

(21) Appl. No.: 18/710,406

(22) PCT Filed: Nov. 8, 2022
(86) PCT No.: PCT/JP2022/041484

§ 371 Date: May 15, 2024

(30) Foreign Application Priority Data
Nov. 29, 2021 (JP) 2021-192704
Aug. 1, 2022 (JP) 2022-122430

(51) Int. Cl. C08K 9/10; B01J 13/04; C08G 59/40; C08G 59/70; C08K 5/00; C08K 5/5415

(52) U.S. Cl. CPC C08K 9/10; B01J 13/043; C08G 59/4085; C08G 59/70; C08K 5/0091; C08K 5/5415; C08K 2201/002

(57) ABSTRACT

A latent curing agent includes porous particles retaining an aluminum chelate compound; and a coating on a surface of the porous particles, the coating containing a polyolefin resin, and a silane coupling agent having an isocyanate group.

### TECHNICAL FIELD

The present invention relates to latent curing agents, production methods for latent curing agents, and curable compositions.

### BACKGROUND ART

Aluminum chelate agents form a cationic species (Bronsted acid) capable of curing an epoxy resin at a low temperature when mixed with a silanol compound (see the following reaction scheme). However, it is challenging to put them into practice because of lacking latency.

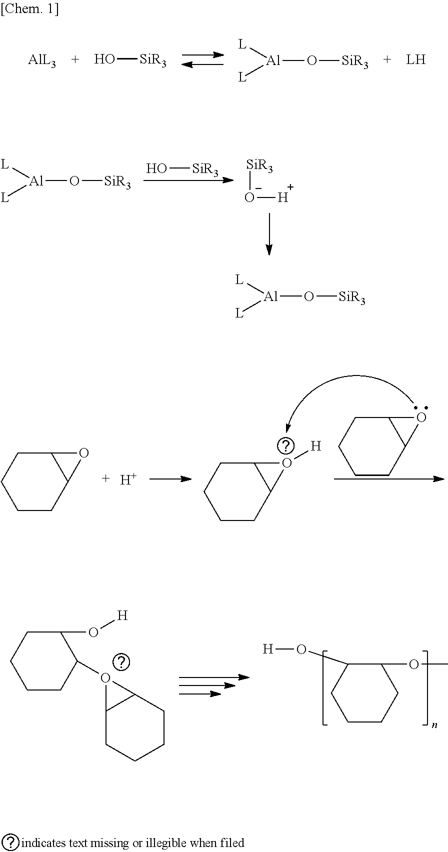

Therefore, by microencapsulating the aluminum chelate agent with a polyurea resin-containing thermoresponsive resin (see FIG. 1), the epoxy resin can be quickly cured at a specific low temperature, and one-pack storage stability thereof in the epoxy resin can be realized. For the preparation of microcapsules, interfacial polymerization using an isocyanate compound is used. FIG. 1 is a schematic cross-sectional diagram (porous structure) of a microencapsulated catalyst particle.

The aluminum chelate agent in the microcapsules exists in a state of being retained in pores (porous structure) formed by volatilizing and removing the solvent during polymerization (multicore type).

When the polyurea resin is heated to a temperature higher than or equal to the glass transition temperature (Tg), hydrogen bonds are cleaved and the intermolecular distance becomes longer, and substance permeability is increased. This mechanism is applied to thermal responsiveness of catalyst particles. That is, a silanol compound is added to the epoxy resin, and the aluminum chelate agent in the microcapsule is contacted with the silanol compound external of the microcapsule at a specific temperature, enabling initiating curing of the epoxy resin.

A related art document proposes a production method for a microcapsule-type curing agent, and a resin composition thereof. The proposed production method includes: suspending and dispersing a cationic polymerization initiator (a sulfonium salt compound) in a solution containing an organic compound (an α-olefin polymer) having a melting point of from 50° C. through 130° C.; and spray-drying the resulting suspension with a spray dryer (solvent removal), thereby producing a microcapsule-type curing agent including: a core component that is a cationic polymerization initiator; and a shell component that is an organic compound encapsulating the cationic polymerization initiator (see, for example, Patent Document 1).

Another related art document proposes a production method for a capsule-type curing agent (including a curing accelerator) and a resin composition thereof. The proposed production method includes removing water under reduced pressure from an emulsified liquid obtained by emulsifying and dispersing an aqueous solution, prepared using a water-soluble curing agent (including a curing accelerator) and a water-soluble polymer, in a non-polar solvent (isoparaffin-based solvent in Examples), thereby producing a capsule-type curing agent (including a curing accelerator) encapsulating the water-soluble curing agent (or the curing accelerator) in a shell formed of the water-soluble polymer (see, for example, Patent Document 2). In this proposal, for improvement in durability, an outer layer containing a hydrophobic polymer is formed on the outer surface of the microcapsule. Disclosed examples of formation of the outer layer include: formation of a polybenzyl methacrylate layer using an azo initiator; and formation of a COC (ethylene-norbornene copolymer) coating on the surface of the microcapsule by dispersing a capsule-type curing agent in a COC solution, followed by spray drying with a spray dryer.

Also, the present inventor previously proposed a latent curing agent, a production method therefor, and a thermosetting epoxy resin composition based on a technique of forming a polymer coating on the surface of a curing agent particle from an alicyclic epoxy compound containing an unreacted alicyclic epoxy compound. The proposed production method includes: performing additional filling of an aluminum chelate agent by a treatment of impregnating a polyurea-based porous curing agent with the aluminum chelate agent, the polyurea-based porous curing agent being prepared using an aluminum chelate agent and triphenylsilanol; and then performing reaction with an alicyclic epoxy resin (see, for example, Patent Document 3).

Also, the present inventor previously proposed a production method for an aluminum chelate-based latent curing agent and a thermosetting epoxy resin composition based on a technique of forming a polymer coating through polymerization of an epoxy site of an epoxy alkoxysilane coupling agent. The proposed production method includes: performing additional filling of an aluminum chelate agent by a treatment of impregnating a polyurea-based porous curing agent with the aluminum chelate agent, the polyurea-based porous curing agent being prepared using an aluminum chelate agent and triphenylsilanol; and then performing a treatment with a solution containing an epoxy alkoxysilane coupling agent (see, for example, Patent Document 4).

Also, the present inventor previously proposed a production method for an aluminum chelate-based latent curing agent and a thermosetting epoxy resin composition based on a technique of forming an alumina coating on the surface of a curing agent particle. The proposed production method includes: performing additional filling of an aluminum chelate agent by a treatment of impregnating a polyurea-based porous curing agent with the aluminum chelate agent, the polyurea-based porous curing agent being prepared using an aluminum chelate agent and triphenylsilanol; and then performing a treatment in an alumina sol (see, for example, Patent Document 5).

### CITATION LIST

### Patent Literature

Patent Document 1: Japanese Laid-Open Patent Application No. 2012-140574

Patent Document 2: Japanese Laid-Open Patent Application No. 2017-222782

Patent Document 3: Japanese Patent No. 6670688

Patent Document 4: Japanese Patent No. 6875999

Patent Document 5: Japanese Laid-Open Patent Application No. 2020-139169

### SUMMARY OF THE INVENTION

### Technical Problem

In Patent Document 1, however, the cationic polymerization initiator is only suspended and dispersed in the organic compound, and thus, the cationic polymerization initiator is also present on the surface of the microcapsule-type curing agent. Therefore, the production method of Patent Document 1 cannot achieve sufficient one-pack storage stability. In addition, upon removing the organic solvent through drying with a spray dryer, a high-temperature treatment (dried at 110° C. using toluene in Examples) is required. Thus, a heat-labile active curing agent cannot be used. In addition, the spray droplet size of the spray dryer is at least several tens of microns or more, and thus, the curing agent obtained by the production method of Patent Document 1 is limited in applications thereof. That is, it cannot be applied as a fine pitch bonding agent.

Also, the material to which latency can be imparted as described in Patent Document 2 is limited to a water-soluble curing agent or a water-soluble curing accelerator. Specific examples thereof are imidazole compounds, amine compounds, hydrazide compounds, phenolic compounds, or the like. Therefore, a highly active curing agent that reacts with water, such as an aluminum chelate compound, or a curing agent that is insoluble in water, such as an amine adduct or the like, cannot be used. Moreover, warming is required during dehydration (treated at 70° C. under reduced pressure in Examples), and thus, a heat-labile curing agent cannot be used.

Also, the coating of the curing agent as described in Patent Document 3 is a polymer coating formed of an alicyclic epoxy compound having polarity, and thus, sufficient latency cannot be obtained in a polar solvent system or a low-viscosity epoxy system.

Also, the coating of the curing agent as described in Patent Document 4 is a polymerized product of a monofunctional epoxy compound, and thus, sufficient latency cannot be obtained in a polar solvent system or a low-viscosity epoxy system.

Also, the alumina coating on the surface of the curing agent particle as described in Patent Document 5 does not exhibit thermal responsiveness, and thus, the curing temperature of the curing agent is increased after formation of the coating.

The present invention aims to address the above-described existing issues and achieve the following object. That is, it is an object of the present invention to provide: a latent curing agent that can be cured at a temperature lower than before and is greatly improved in one-pack storage stability; a production method for the latent curing agent; and a curable composition containing the latent curing agent.

### Solution to the Problem

Means for addressing the above issues are as follows.

<1> A latent curing agent, including:
porous particles retaining an aluminum chelate compound; and
a coating on a surface of the porous particles, the coating containing a polyolefin resin, and a silane coupling agent having an isocyanate group.

<2> The latent curing agent as described in <1>, in which an average surface roughness of the porous particles is 5 nm or less.

<3> The latent curing agent as described in <1> or <2>, in which the polyolefin resin is an alicyclic polyolefin resin, an α-olefin copolymer, or both.

<4> The latent curing agent as described in <3>, in which a glass transition temperature of the alicyclic polyolefin resin is 140° C. or lower.

<5> The latent curing agent as described in <3>, in which the alicyclic polyolefin resin is a cycloolefin copolymer (COC), a cycloolefin homopolymer (COP), or both.

<6> The latent curing agent as described in <3>, in which the α-olefin copolymer has a melting point of 100° C. or lower.

<7> The latent curing agent as described in <1> or <2>, in which the porous particles include a polyurea resin.

<8> The latent curing agent as described in <7>, in which the porous particles further include a polymerized product of a radical-polymerizable monomer having a long-chain structure.

<9> The latent curing agent as described in <1> or <2>, in which the porous particles retain a silanol compound.

<10> A production method for a latent curing agent, the production method including:
spray-drying a dispersion liquid obtained by dispersing porous particles retaining an aluminum chelate compound in a treatment liquid, the treatment liquid containing a polyolefin resin and a silane coupling agent having an isocyanate group in an organic solvent.

<11> The production method for the latent curing agent as described in <10>, in which an average surface roughness of the porous particles is 5 nm or less.

<12> The production method for the latent curing agent as described in <10> or <11>, in which a content of the polyolefin resin in the treatment liquid is 1.5% by mass or less.

<13> The production method for the latent curing agent as described in <10> or <11>, in which a content of the silane coupling agent having the isocyanate group in the treatment liquid is 0.5% by mass or less.

<14> A curable composition, including:
the latent curing agent of <1> or <2>; and
a cationically curable compound.

<15> The curable composition as described in <14>, in which the cationically curable compound is an epoxy compound or an oxetane compound.

<16> The curable composition as described in <14>, further including a silanol compound.

### Advantageous Effects of the Invention

The present invention addresses the above-described existing issues and achieves the above object, and can provide: a curing agent that can be cured at a temperature lower than before and is greatly improved in one-pack storage stability; a production method for the curing agent; and a curable composition containing the curing agent.

### BRIEF DESCRIPTION OF THE DRAWINGS

FIG. 1 is a schematic diagram illustrating an example of latency of an aluminum chelate agent.

FIG. 2 is a schematic diagram illustrating an example of a latent curing agent of the present invention.

FIG. 3 is a chart illustrating results of DSC measurement of curable compositions containing curing agents of Comparative Examples 1 and 2.

FIG. 4 is a graph illustrating viscosity change of the curable compositions containing the curing agents of Comparative Examples 1 and 2.

FIG. 5 is a chart illustrating results of DSC measurement of curable compositions containing curing agents of Comparative Examples 3 and 4.

FIG. 6 is a graph illustrating viscosity change of the curable compositions containing the curing agents of Comparative Examples 3 and 4.

FIG. 7 is a diagram illustrating results obtained by measuring an average surface roughness of catalyst powder A through AFM.

FIG. 8 is a diagram illustrating results obtained by measuring an average surface roughness of catalyst powder B through AFM.

FIG. 9A is an SEM image of catalyst powder A (at a magnification of 35,000).

FIG. 9B is an SEM image of catalyst powder A (at a magnification of 100,000).

FIG. 10A is an SEM image of catalyst powder B (at a magnification of 25,000).

FIG. 10B is an SEM image of catalyst powder B (at a magnification of 100,000).

FIG. 11 is a chart illustrating results of DSC measurement of curable compositions containing curing agents of Example 1 and Comparative Example 3.

FIG. 12 is a chart illustrating results of DSC measurement of curable compositions containing curing agents of Example 2 and Comparative Example 3.

FIG. 13 is a graph illustrating viscosity change of curable compositions containing curing agents of Examples 1 and 2 and Comparative Example 3.

FIG. 14 is a graph illustrating volume-based particle size distributions of curing agents of Examples 1 and 2 and Comparative Example 3.

FIG. 15A is an SEM image of a latent curing agent of Example 1 (at a magnification of 3,000).

FIG. 15B is an SEM image of the latent curing agent of Example 1 (at a magnification of 12,000).

FIG. 16A is an SEM image of a latent curing agent of Example 2 (at a magnification of 3,000).

FIG. 16B is an SEM image of the latent curing agent of Example 2 (at a magnification of 12,000).

FIG. 17 is a chart illustrating results of DSC measurement of curable compositions containing curing agents of Example 3 and Comparative Example 5.

FIG. 18 is a graph illustrating viscosity change of curable compositions containing the curing agents of Example 3 and Comparative Example 5.

FIG. 19 is a graph illustrating volume-based particle size distributions of the curing agents of Example 3 and Comparative Example 5.

FIG. 20A is an SEM image of the latent curing agent of Example 3 (at a magnification of 5,000).

FIG. 20B is an SEM image of the latent curing agent of Example 3 (at a magnification of 20,000).

FIG. 21 is a graph illustrating a correlation between a COC resin concentration and TG (mg).

FIG. 22 is a chart illustrating results of DSC measurement of curable compositions containing curing agents of Example 4 and Comparative Examples 1 and 2.

FIG. 23 is a graph illustrating viscosity change of curable compositions containing the curing agents of Example 4 and Comparative Examples 1 and 2.

FIG. 24 is a chart illustrating results of DSC measurement of curable compositions containing curing agents of Example 5 and Comparative Example 3.

FIG. 25 is a graph illustrating viscosity change of the curable compositions containing the curing agents of Example 5 and Comparative Example 3.

FIG. 26 is a graph illustrating volume-based particle size distributions of the curing agents of Example 5 and Comparative Example 3.

FIG. 27A is an SEM image of a latent curing agent of Example 5 (at a magnification of 3,000).

FIG. 27B is an SEM image of the latent curing agent of Example 5 (at a magnification of 12,000).

### DETAILED DESCRIPTION OF THE INVENTION

### (Latent Curing Agent)

The latent curing agent of the present invention includes porous particles retaining an aluminum chelate compound, and a coating on a surface of the porous particles, the coating containing a polyolefin resin, and a silane coupling agent having an isocyanate group.

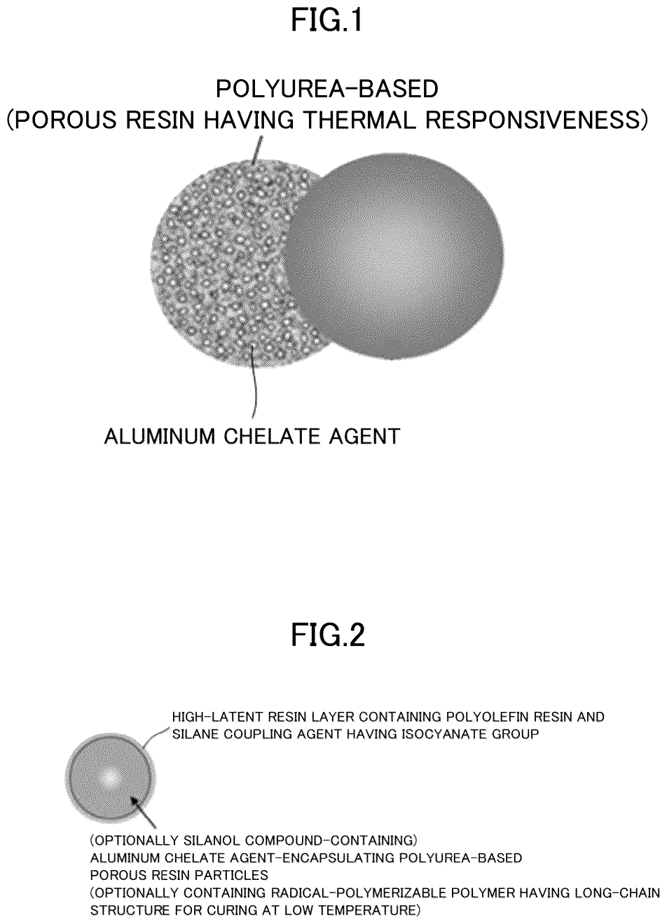

FIG. 2 is a schematic diagram illustrating an example of the latent curing agent of the present invention. In the latent curing agent of FIG. 2, the coating containing the polyolefin resin and the silane coupling agent having the isocyanate group is formed on the surface of the porous particles retaining the aluminum chelate compound. By containing the silane coupling agent having the isocyanate group, the coating containing the polyolefin resin, intrinsically having poor attachability and poor adhesiveness, can be uniformly formed on the surface of the porous particles. Also, the polyolefin resin has excellent resistance to polar solvents, and the silane coupling agent having the isocyanate group has an effect of reducing activity of the aluminum chelate compound remaining on the surface of the catalyst powder. Thus, the latent curing agent of the present invention exhibits excellent one-pack storage stability at room temperature. Further, the coating on the surface of the porous particles includes an alicyclic polyolefin resin having a low glass transition temperature (Tg) or an α-olefin copolymer having a low melting point (Tm), and is a thin film. Thus, it is possible to achieve high latency in a state in which the intrinsic low-temperature activity of the catalyst is maintained.

In the present invention, the surface of the porous particles includes the polyolefin resin and the silane coupling agent having the isocyanate group. No particular limitation is imposed on the surface of the porous particles including the polyolefin resin and the silane coupling agent having the isocyanate group as long as the polyolefin resin and the silane coupling agent having the isocyanate group are present on the surface of the porous particles. It is preferable that the coating containing the polyolefin resin and the silane coupling agent having the isocyanate group be formed. However, the polyolefin resin and the silane coupling agent having the isocyanate group may be retained on the surface of the porous particles by the action of some interaction, such as attachment, adhesion, adsorption, van der Waals bonding, or the like.

When the polyolefin resin and the silane coupling agent having the isocyanate group form a coating on the surface of the porous particles, the coating may be formed on at least a part of the surface of the porous particles, or may be formed to cover the entire surface of the porous particles. The coating may be formed as a continuous film, or may contain a discontinuous film in at least a part thereof.

An analysis method for confirming that the polyolefin resin is present on the surface of the porous particles is, for example, as follows. Specifically, the polyolefin resin on the porous particles is dissolved in a solvent that selectively dissolves the polyolefin resin, and the polyolefin resin in the solution is analyzed by a thermogravimetric differential thermal analyzer (TG/DTA) or the like. Examples of the solvent that selectively dissolves the polyolefin resin include cyclohexane, chlorobenzene, and the like.

Also, an analysis method for confirming that the silane coupling agent having the isocyanate group is present on the surface of the porous particles is, for example, as follows. Specifically, Si atoms derived from the silane coupling agent having the isocyanate group present on the surface of the porous particles are analyzed through X-ray photoelectron spectroscopy (XPS) or the like.

### <Porous Particles Retaining Aluminum Chelate Compound>

The porous particles are formed of a polyurea resin.

The porous particles retain an aluminum chelate compound.

The porous particles retain the aluminum chelate compound in, for example, the pores thereof. In other words, the aluminum chelate compound is taken into and retained in the minute pores present in the porous particle matrix formed of the polyurea resin.

The average surface roughness of the porous particles is preferably 5 nm or less. Even if the surface of the porous particles has a small average surface roughness and is less likely to exhibit an anchoring effect, addition of the silane coupling agent having the isocyanate group enables uniform formation of the coating containing the polyolefin resin, intrinsically having poor attachability and poor adhesiveness.

The average surface roughness of the porous particles can be measured, for example, by an atomic force microscope (AFM).

### -Polyurea Resin-

The polyurea resin is a resin that contains a urea bond in the resin.

The polyurea resin constituting the porous particles is obtained by, for example, polymerization of a multifunctional isocyanate compound in an emulsified liquid. Details thereof will be described below. The polyurea resin may contain, in the resin, a bond that is derived from an isocyanate group and is other than a urea bond, such as a urethane bond or the like. When the polyurea resin contains a urethane bond, it may be referred to as a polyurea-urethane resin.

### -Aluminum Chelate Compound-

Examples of the aluminum chelate compound include complex compounds, which, as represented by general formula (1) below, are aluminum to which three β-ketoenolate anions are coordinated. Here, the alkoxy groups are not directly bonded to aluminum, because if the alkoxy groups are directly bonded, the aluminum chelate compound is more likely to hydrolyze and is unsuitable for an emulsification treatment.

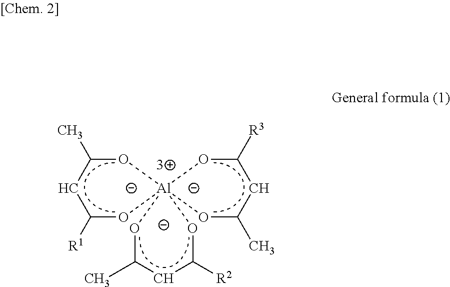

In general formula (1), R¹, R², and R³ each independently represent an alkyl group or an alkoxy group.

Examples of the alkyl group include a methyl group, an ethyl group, and the like.

Examples of the alkoxy group include a methoxy group, an ethoxy group, an oleyloxy group, and the like.

Examples of the complex compounds represented by general formula (1) include aluminum tris(acetyl acetonate), aluminum tris(ethyl acetoacetate), aluminum monoacetyl acetonate bis(ethyl acetoacetate), aluminum monoacetyl acetonate bis(oleyl acetoacetate), and the like. These may be used alone or in combination.

The aluminum chelate compound is a compound that cannot be dissolved in water because the aluminum chelate compound exothermically decomposes upon contact with water. Therefore, the porous particles retaining the aluminum chelate compound are a curing catalyst that should avoid contact with water.

No particular limitation is imposed on the content of the aluminum chelate compound in the porous particles, which may be appropriately selected in accordance with the intended purpose.

No particular limitation is imposed the average pore diameter of the pores of the porous particles, which may be appropriately selected in accordance with the intended purpose. The average pore diameter thereof is preferably 1 nm or greater and 300 nm or less and more preferably 5 nm or greater and 150 nm or less.

No particular limitation is imposed on the volume average particle diameter of the porous particles, which may be appropriately selected in accordance with the intended purpose. The volume average particle diameter thereof is preferably 10 μm or less, more preferably 1 μm or greater and 10 μm or less, and particularly preferably 1 μm or greater and 5 μm or less.

The porous particles preferably contain a polymerized product (polymer) of a radical-polymerizable monomer having a long-chain structure. When the porous particles contain a polymerized product of a radical-polymerizable monomer having a long-chain structure, it is possible to increase the distance between crosslinking points and enhance low-temperature reactivity.

The radical-polymerizable monomer having the long chain structure contains at least one addition-polymerizable ethylene group, and examples thereof include (meth)acrylates having a polyoxyalkylene chain. In this specification, “(meth)acrylate” is used as a generic term of “acrylate” and “methacrylate”.

The polyoxyalkylene group is a group having an oxyalkylene group as a repeating unit. The polyoxyalkylene group is preferably a group represented by formula (E) below.

-(A-O)m- Formula (E)

A represents an alkylene group. No particular limitation is imposed on the number of carbon atoms in the alkylene group, which is preferably from one through four and more preferably two or three. For example, when A is an alkylene group having one carbon atom, -(A-O)— is an oxymethylene group (—CH₂O—), when A is an alkylene group having two carbon atoms, -(A-O)— is an oxyethylene group (—CH₂CH₂O—), and when A is an alkylene group having three carbon atoms, -(A-O)— is an oxypropylene group (—CH₂CH(CH₃)O—, —CH(CH₃)CH₂O—, or —CH₂CH₂CH—O—). The alkylene group may be linear or branched.

m represents the number of repetitions of the oxyalkylene group, and represents an integer of 2 or more. The number “m” of repetitions is limited so that the number of atoms of the backbone of the linked chain is from 25 through 100.

The number of carbon atoms of the alkylene groups in multiple oxyalkylene groups may be the same or different. For example, in formula (E), multiple repeating units each represented by -(A-O)— are included, and the number of carbon atoms of the alkylene group in each repeating unit may be the same or different. For example, in formula (E): -(A-O)m-, an oxymethylene group and an oxypropylene group may be included.

Also, when multiple types of oxyalkylene groups are included, no particular limitation is imposed on the order of bonding thereof. The multiple types of oxyalkylene groups may be bonded in a random or block form.

Examples of the (meth)acrylate having the polyoxyalkylene chain include polyethylene glycol mono(meth)acrylate, polyethylene glycol di(meth)acrylate, polypropylene glycol mono(meth)acrylate, polypropylene glycol mono(meth)diacrylate, poly(ethylene glycol-propylene glycol) mono(meth)acrylate, poly(ethylene glycol-propylene glycol) di(meth)acrylate, polyethylene glycol-polypropylene glycol mono(meth)acrylate, polyethylene glycol-polypropylene glycol di(meth)acrylate, and the like. These may be used alone or in combination.

The porous particles preferably retain the silanol compound. When the porous particles retain the silanol compound, it is possible to achieve epoxy curing by the latent curing agent alone without adding the silanol compound on the epoxy resin.

As the silanol compound, those that are similar to silanol compounds in the below-described curable composition can be used.

### [Production Method for Porous Particles Retaining Aluminum Chelate Compound]

The production method for the porous particles retaining the aluminum chelate compound includes a porous particle producing step and further includes other steps, if necessary.

### -Porous Particle Producing Step-

The porous particle producing step includes at least an emulsified liquid producing treatment and a polymerization treatment, preferably includes a highly impregnating treatment, and further includes other treatments, if necessary.

### —Emulsified Liquid Producing Treatment—

No particular limitation is imposed on the emulsified liquid producing treatment, which may be appropriately selected in accordance with the intended purpose, as long as the emulsified liquid producing treatment is a treatment of emulsifying a liquid obtained by mixing an aluminum chelate compound, a multifunctional isocyanate compound, and an organic solvent, and preferably a radical polymerizable compound, thereby producing an emulsified liquid. The emulsified liquid producing treatment can be performed using, for example, a homogenizer.

Examples of the aluminum chelate compound include the aluminum chelate compound described in the description about the latent curing agent of the present invention.

No particular limitation is imposed on the size of oil droplets in the emulsified liquid, which may be appropriately selected in accordance with the intended purpose. The size of oil droplets is preferably 0.5 μm or greater and 100 μm or less.

### —Multifunctional Isocyanate Compound—

The multifunctional isocyanate compound is a compound that contains two or more isocyanate groups, preferably three isocyanate groups, in one molecule. More preferable examples of such a trifunctional isocyanate compound include: TMP adduct forms represented by general formula (2) below, obtained by reacting 3 moles of a diisocyanate compound with 1 mole of trimethylolpropane; isocyanurate forms represented by general formula (3) below, obtained by self-condensing 3 moles of a diisocyanate compound; and biuret forms represented by general formula (4) below, obtained as a result of diisocyanate urea obtained from 2 moles out of 3 moles of a diisocyanate compound undergoing condensation with the remaining 1 mole of diisocyanate.

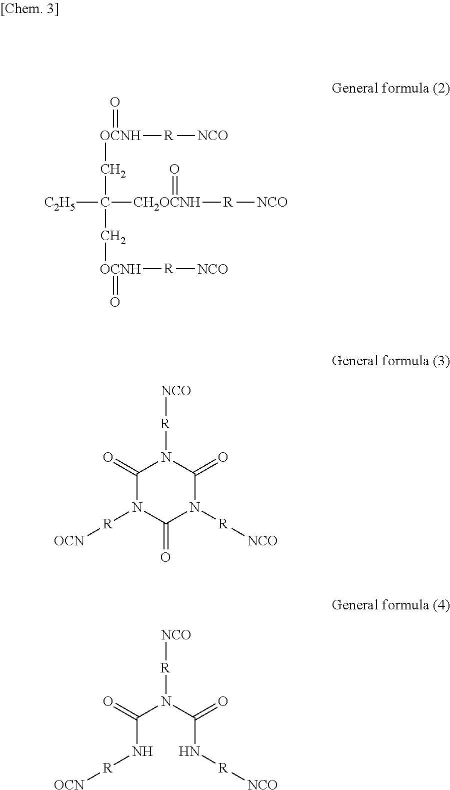

In general formulae (2) to (4), a substituent R is a moiety of the diisocyanate compound except an isocyanate group. Specific examples of such a diisocyanate compound include toluene 2,4-diisocyanate, toluene 2,6-diisocyanate, m-xylylene diisocyanate, hexamethylene diisocyanate, hexahydro-m-xylylene diisocyanate, isophorone diisocyanate, methylene diphenyl-4,4′-diisocyanate, and the like. These may be used alone or in combination.

No particular limitation is imposed on the ratio of amounts between the aluminum chelate compound and the multifunctional isocyanate compound, which may be appropriately selected in accordance with the intended purpose. When the amount of the aluminum chelate compound is extremely low, the curing ability for a cationically curable compound to be cured is low. When the amount of the aluminum chelate compound is extremely high, the latency of the latent curing agent to be obtained is low. In these regards, the amount of the aluminum chelate compound is preferably 10 parts by mass or greater and 500 parts by mass or less and more preferably 10 parts by mass or greater and 300 parts by mass or less relative to 100 parts by mass of the multifunctional isocyanate compound.

Examples of the radical-polymerizable compound include divinylbenzene. When producing catalyst powder (porous particles) exhibiting low-temperature activity, a radical-polymerizable monomer having a long-chain structure is added instead of divinylbenzene. Examples of the radical-polymerizable monomer having the long-chain structure include polyethylene glycol diacrylate.

### —Organic Solvent—

No particular limitation is imposed on the organic solvent, which may be appropriately selected in accordance with the intended purpose. However, a volatile organic solvent is preferable.

It is preferable that the organic solvent be a good solvent for each of the aluminum chelate compound and the multifunctional isocyanate compound (each having a solubility of preferably 0.1 g/ml (organic solvent) or greater), be substantially insoluble in water (water having a solubility of 0.5 g/ml (organic solvent) or less), and have a boiling point of 100° C. or lower under the atmospheric pressure. Specific examples of such a volatile organic solvent include alcohols, acetic acid esters, ketones, and the like. Of these volatile organic solvents, ethyl acetate is preferable in terms of having a high polarity, a low boiling point, and poor water-solubility.

No particular limitation is imposed on the amount of the organic solvent to be used, which may be appropriately selected in accordance with the intended purpose.

### -Polymerization Treatment-

No particular limitation is imposed on the polymerization treatment, which may be appropriately selected in accordance with the intended purpose as long as the polymerization treatment is a treatment of polymerizing the multifunctional isocyanate compound in the emulsified liquid to produce porous particles.

The porous particles retain the aluminum chelate compound.

In the polymerization treatment, some isocyanate groups of the multifunctional isocyanate compound are hydrolyzed to amino groups, and these amino groups are reacted with isocyanate groups of the multifunctional isocyanate compound to produce urea bonds, thereby yielding a polyurea resin. Here, when the multifunctional isocyanate compound contains a urethane bond, the resulting polyurea resin also contains a urethane bond. In this regard, the resulting polyurea resin can also be referred to as a polyurea urethane resin.

No particular limitation is imposed on the polymerization time in the polymerization treatment, which may be appropriately selected in accordance with the intended purpose. The polymerization time is preferably 1 hour or longer and 30 hours or shorter and more preferably 2 hours or longer and 10 hours or shorter.

No particular limitation is imposed on the polymerization temperature in the polymerization treatment, which may be appropriately selected in accordance with the intended purpose. The polymerization temperature is preferably 30° C. or higher and 90° C. or lower and more preferably 50° C. or higher and 80° C. or lower.

After the polymerization treatment, it is possible to perform a highly impregnating treatment of the aluminum chelate compound in order to increase the amount of the aluminum chelate compound to be retained by the porous particles.

### -Highly Impregnating Treatment-

No particular limitation is imposed on the highly impregnating treatment, which may be appropriately selected in accordance with the intended purpose as long as the highly impregnating treatment is a treatment of additionally filling an aluminum chelate compound to the porous particles obtained through the polymerization treatment. Examples of the method for the highly impregnating treatment include a method of immersing the porous particles in a solution obtained by dissolving an aluminum chelate compound in an organic solvent and subsequently removing the organic solvent from the solution.

Through the highly impregnating treatment, the amount of the aluminum chelate compound to be retained by the porous particles increases. The porous particles to which the aluminum chelate compound is additionally filled may be optionally filtrated, and washed and dried, and subsequently crushed to primary particles with a publicly known crusher.

The aluminum chelate compound to be additionally filled in the highly impregnating treatment may be the same as or different from the aluminum chelate compound mixed in the liquid that which is to become the emulsified liquid. For example, because no water is used in the highly impregnating treatment, the aluminum chelate compound used in the highly impregnating treatment may be an aluminum chelate compound in which alkoxy groups are bonded to aluminum. Examples of such an aluminum chelate compound include diisopropoxyaluminum monooleyl acetoacetate, monoisopropoxyaluminum bis(oleyl acetoacetate), monoisopropoxyaluminum monooleate monoethyl acetoacetate, diisopropoxyaluminum monolauryl acetoacetate, diisopropoxyaluminum monostearyl acetoacetate, diisopropoxyaluminum monoisostearyl acetoacetate, monoisopropoxyaluminum mono-N-lauroyl-β-alanate monolauryl acetoacetate, and the like. These may be used alone or in combination.

No particular limitation is imposed on the organic solvent, which may be appropriately selected in accordance with the intended purpose. Examples of the organic solvent include the organic solvents listed as examples in the description about the emulsified liquid producing treatment. A preferable embodiment is also the same.

No particular limitation is imposed on the method for removing the organic solvent from the solution, which may be appropriately selected in accordance with the intended purpose. Examples of the method include a method of heating the solution to higher than or equal to the boiling point of the organic solvent, a method of depressurizing the solution, and the like.

No particular limitation is imposed on the content of the aluminum chelate compound in the solution obtained by dissolving the aluminum chelate compound in the organic solvent, which may be appropriately selected in accordance with the intended purpose. The content of the aluminum chelate compound is preferably 10% by mass or greater and 80% by mass or less and more preferably 10% by mass or greater and 50% by mass or less.

### <Polyolefin Resin>

Examples of the polyolefin resin include alicyclic polyolefin resins, α-olefin copolymers, and the like. These may be used alone or in combination.

### -Alicyclic Polyolefin Resin-

The alicyclic polyolefin resin is a thermoplastic resin excellent in resistance to polar solvents and represents a polymer resin having an alicyclic olefin structure.

Examples of the alicyclic polyolefin resin include: (1) norbornene-based polymers; (2) monocyclic olefin polymers; (3) cyclic conjugated diene polymers; (4) vinyl alicyclic hydrocarbon polymers; and hydrides of (1) to (4).

Polymers that are preferable in the present invention are addition (co)polymer cyclic polyolefins containing at least one or more repeating units represented by general formula (II), and addition (co)polymer cyclic polyolefins optionally further containing at least one or more repeating units represented by general formula (I). Ring-opening (co)polymers containing at least one cyclic repeating unit represented by general formulae (III) and (IV) can also be successfully used. Of these, the polymers that are preferable in the present invention are cycloolefin copolymers (cycloolefin copolymers (COC resins), ethylene-norbornene copolymers), cycloolefin homopolymers (cycloolefin polymers (COP resins)), or both.

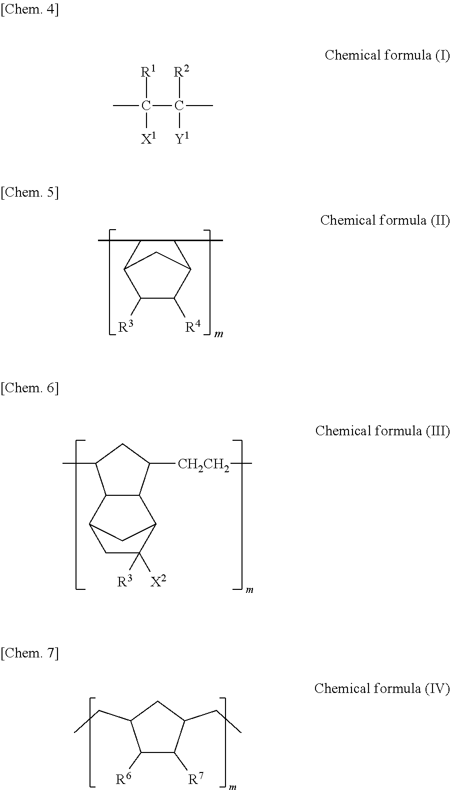

However, in general formulae (I) to (IV), m represents an integer of from 0 through 10.

R¹ to R⁷ represent a hydrogen atom or a hydrocarbon group having from 1 through 10 carbon atoms.

X¹, X², and Y¹ represent a hydrogen atom, a hydrocarbon group having from 1 through 10 carbon atoms, a halogen atom, a halogen atom-substituted hydrocarbon group having from 1 through 10 carbon atoms, —(CH₂)ₙCOOR⁸, —(CH₂)ₙOCOR⁹, —(CH₂)ₙNCO, —(CH₂)ₙNO₂, —(CH₂)ₙCN, —(CH₂)ₙCONR¹⁰R¹¹, —(CH₂)ₙNR¹⁰R¹¹, —(CH₂)ₙOZ, or —(CH₂)ₙW; or (—CO)₂O or (—CO)₂NR¹² each formed of X¹ and Y¹ or X² and Y¹. R⁸, R⁹, R¹⁰, R¹¹, and R³² represent a hydrogen atom, a hydrocarbon group having from 1 through 20 carbon atoms, Z represents a hydrocarbon group having from 1 through 10 carbon atoms or a halogen atom-substituted hydrocarbon group having from 1 through 10 carbon atoms, and W represents SiR¹³ₚD₃₋ₚ (R¹³ represents a hydrocarbon group having from 1 through 10 carbon atoms, D represents a halogen atom, —OCOR¹⁴, or OR¹⁴, and p represents an integer of from 0 through 3). R¹⁴ represents a hydrogen atom or a hydrocarbon group having from 1 through 10 carbon atoms, and n represents an integer of from 0 through 10.

The norbornene-based polymer hydride is synthesized through addition polymerization or metathesis ring-opening polymerization of a polycyclic unsaturated compound, followed by hydrogenation, as disclosed in Japanese Laid-Open Patent Application No. 1989-240517, 1995-196736, 1985-26024, 1987-19801, 2003-1159767, 2004-309979, or the like.

In the norbornene-based polymer, R⁵ to R⁷ are preferably a hydrogen atom or —CH³, X² is preferably a hydrogen atom, Cl, or —COOCH₃, and the other groups are appropriately selected.

The norbornene-based resin is commercially available in the product name of Arton from JSR Corporation, and in the product names Zeonor and Zeonex from Zeon Corporation.

The norbornene-based addition (co)polymer is disclosed in Japanese Laid-Open Patent Application No. 1998-7732, PCT Japanese Translation Patent Publication No. 2002-504184, US2004229157A1, WO2004/070463A1, and the like. The norbornene-based addition (co)polymer is obtained through addition polymerization between norbornene-based polycyclic unsaturated compounds. Also, the norbornene-based addition (co)polymer is obtained through addition polymerization between: norbornene-based polycyclic unsaturated compounds and if necessary, conjugated dienes, such as ethylene, propylene, butene, butadiene, and isoprene; non-conjugated dienes, such as ethylidene norbornene; and linear diene compounds, such as acrylonitrile, acrylic acid, methacrylic acid, maleic anhydride, acrylic acid ester, methacrylic acid ester, maleimide, vinyl acetate, vinyl chloride, and the like.

The norbornene-based addition (co)polymer is commercially available in the product name of Apel from Mitsui Chemicals, Inc. Also, the norbornene-based addition (co)polymer is commercially available as a pellet in the product name of TOPAS from Polyplastics Co., Ltd.

The glass transition temperature (Tg) of the alicyclic polyolefin resin is preferably 140° C. or lower, more preferably 135° C. or lower, and more preferably 120° C. or lower. By using a low Tg alicyclic polyolefin resin having a glass transition temperature of 140° C. or lower, advantageously, thermal responsiveness (based on cleavage of hydrogen bonds) of the porous particles retaining the aluminum chelate compound is not inhibited even if the porous particles are coated with the alicyclic polyolefin resin.

### -α-Olefin Copolymer-

The α-olefin copolymer is preferably a copolymer containing an α-olefin-derived constituent component and another olefin-derived constituent component different from the α-olefin.

Generally, the α-olefin may contain only one type of an α-olefin having from 2 through 20 carbon atoms or may contain two or more types thereof in combination. Of these, a preferred α-olefin is an α-olefin having 3 or more carbon atoms, and an α-olefin having from 3 through 8 carbon atoms is particularly preferable.

Examples of the α-olefin include 1-butene, 1-pentene, 1-hexene, 3-methyl-1-butene, 3,3-dimethyl-1-butene, 4-methyl-1-pentene, 1-octene, and the like. These may be used alone or in combination. Of these, 1-butene, 1-pentene, 1-hexene, and 4-methyl-1-pentene are preferable in terms of ease of procurement.

Other olefins different from the above α-olefins are preferably olefins having from 2 through 4 carbon atoms, such as ethylene, propylene, butene, and the like.

Examples of the α-olefin copolymer include an ethylene-propylene copolymer (EPR), an ethylene-1-butene copolymer (EBR), an ethylene-1-pentene copolymer, an ethylene-1-octene copolymer (EOR), a propylene-1-butene copolymer (PBR), a propylene-1-pentene copolymer, a propylene-1-octene copolymer (POR), and the like. Of these, a copolymer containing an α-olefin-derived constituent component having from 2 through 8 carbon atoms and an olefin-derived constituent component having 2 or 3 carbon atoms is preferable.

The α-olefin copolymer may be a random copolymer or a block copolymer.

The melting point of the α-olefin copolymer is preferably 100° C. or lower and more preferably 50° C. or higher and 100° C. or lower. The α-olefin copolymer having a melting point of 100° C. or lower has a melting point lower than that of a polyurea resin. Thus, the α-olefin copolymer having a melting point of 100° C. or lower can be coated on the surface of polyurea-based porous particles without inhibiting thermal responsiveness of the polyurea-based porous particles.

The melting point is a value determined by differential scanning calorimetry (DSC) as a temperature Tm at the maximum peak position appearing in an endothermic curve.

As the α-olefin copolymer, an appropriately synthesized product or a commercially available product may be used. Examples of the commercially available product include TAFMER (registered trademark) series (e.g., TAFMER XM-7070, TAFMER XM-7080, and TAFMER XM-7090) available from Mitsui Chemicals, Inc.

No particular limitation is imposed on the amount (coating amount) of the polyolefin resin attached in the latent curing agent, which may be appropriately selected in accordance with the intended purpose as long as the resulting latent curing agent can be cured at a temperature lower than before and is greatly improved in one-pack storage stability.

### <Silane Coupling Agent Having Isocyanate Group>

The silane coupling agent having the isocyanate group is a silane coupling agent having at least one isocyanate group in one molecule. The number of isocyanate groups contained in one molecule of the silane coupling agent having the isocyanate group is preferably from 1 through 3 and more preferably 1. The silane coupling agent having the isocyanate group may be referred to as an “isocyanate silane coupling agent”.

Examples of the silane coupling agent having the isocyanate group include trimethoxysilyl methyl isocyanate, triethoxysilyl methyl isocyanate, tripropoxysilyl methyl isocyanate, 2-trimethoxysilyl ethyl isocyanate, 2-triethoxysilyl ethyl isocyanate, 2-tripropoxysilyl ethyl isocyanate, 3-trimethoxysilyl propyl isocyanate, 3-triethoxysilyl propyl isocyanate, 3-tripropoxysilyl propyl isocyanate, 4-trimethoxysilyl butyl isocyanate, 4-triethoxysilyl butyl isocyanate, 4-tripropoxysilyl butyl isocyanate, and the like. These may be used alone or in combination.

As the silane coupling agent having the isocyanate group, a commercially available product may be used. Examples of the commercially available product include KBE-9007N (available from Shin-Etsu Chemical Co., Ltd.).

The silane coupling agent having the isocyanate group is soluble in a polyolefin resin solution prepared using a solvent, such as cyclohexane, methylcyclohexane, or the like.

As shown in the following chemical formulae, the silane coupling agent having the isocyanate group may be bonded via a hydrogen bond to a urea site on the surface of catalyst particles after formation of silanol.

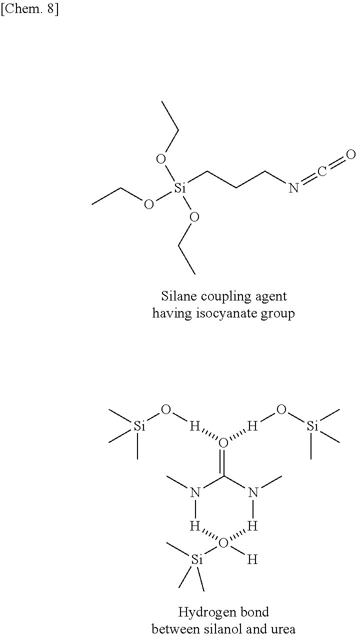

The above effect enables uniform formation of the polyolefin resin layer, intrinsically having poor attachability and poor adhesiveness, on the surface of the catalyst particles having a urea structure.

The silane coupling agent having the isocyanate group forms an active species by interacting with an aluminum chelate agent on the surface of the catalyst particles after formation of silanol (see the following reaction formulae).

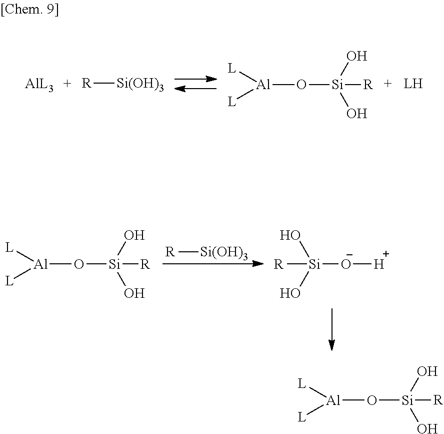

### Mechanism of Formation of Active Species by Aluminum Chelate Agent and Silanol Compound

The formed active species is used for hydrolysis of the silane coupling agent having the isocyanate group or reaction between an isocyanate compound and a silanol compound (urethanization reaction by a metal complex). Thus, by using the silane coupling agent having the isocyanate group, it is possible to reduce the activity of the aluminum chelate compound on the surface of the catalyst particles.

No particular limitation is imposed on the amount (coating amount) of the silane coupling agent having the isocyanate group attached in the latent curing agent, which may be appropriately selected in accordance with the intended purpose as long as the resulting latent curing agent can be cured at a temperature lower than before and is greatly improved in one-pack storage stability.

### (Production Method for Latent Curing Agent)

The production method for the latent curing agent includes spray-drying a dispersion liquid obtained by dispersing porous particles retaining an aluminum chelate compound in a treatment liquid, the treatment liquid containing a polyolefin resin and a silane coupling agent having an isocyanate group in an organic solvent.

The content of the polyolefin resin in the organic solvent is preferably 1.5% by mass or less, more preferably 1% by mass or less, further preferably 0.5% by mass or less, and particularly preferably 0.3% by mass or less. The lower limit of the content thereof is preferably 0.01% by mass or more.

When the content of the polyolefin resin in the organic solvent exceeds 1.5% by mass, defects may occur, such as stringiness and formation of coarse particles during spray drying, poor recovery (stickiness), and the like.

The content of the silane coupling agent having the isocyanate group in the organic solvent is preferably 0.5% by mass or less and more preferably 0.3% by mass or less. The lower limit of the content thereof is preferably 0.01% by mass or more.

When the content of the silane coupling agent having the isocyanate group in the organic solvent exceeds 0.5% by mass, defects may occur, such as poor crushing (stickiness) by the addition of liquid components during crushing with a jet mill.

The content of the porous particles retaining the aluminum chelate compound in the dispersion liquid is preferably 5% by mass or more and 30% by mass or less.

The average surface roughness of the porous particles is preferably 5 nm or less.

The organic solvent is preferably, for example, a chlorine-based solvent, such as dichloromethane, chloroform, or the like; or a solvent selected from chain hydrocarbons having from 3 through 12 carbon atoms, cyclic hydrocarbons having from 3 through 12 carbon atoms, aromatic hydrocarbons having from 6 through 12 carbon atoms, esters, ketones, and ethers. The ester, ketone, and ether may have a cyclic structure.

Examples of the chain hydrocarbon having from 3 through 12 carbon atoms include hexane, octane, isooctane, decane, and the like.

Examples of the cyclic hydrocarbon having from 3 through 12 carbon atoms include cyclopentane, cyclohexane, derivatives thereof, and the like.

Examples of the aromatic hydrocarbon having from 6 through 12 carbon atoms include benzene, toluene, xylene, and the like.

Examples of the ester include ethyl formate, propyl formate, pentyl formate, methyl acetate, ethyl acetate, pentyl acetate, and the like.

Examples of the ketone include acetone, methyl ethyl ketone, diethyl ketone, diisobutyl ketone, cyclopentanone, cyclohexanone, methylcyclohexanone, and the like.

Examples of the ether include diisopropyl ether, dimethoxymethane, dimethoxyethane, 1,4-dioxane, 1,3-dioxolane, tetrahydrofuran, anisole, phenetol, and the like.

No particular limitation is imposed on spray drying, which may be performed using a publicly known spray dryer.

The obtained latent curing agent may be optionally washed with an organic solvent, and roughly crushed and dried, and subsequently crushed to primary particles with a publicly known crusher.

No particular limitation is imposed on the organic solvent used for the washing, which may be appropriately selected in accordance with the intended purpose. The organic solvent is preferably a nonpolar solvent. Examples of the nonpolar solvent include hydrocarbon-based solvents and the like. Examples of the hydrocarbon-based solvents include toluene, xylene, cyclohexane, methylcyclohexane, and the like.

### (Curable Composition)

The curable composition of the present invention contains the latent curing agent of the present invention and an epoxy resin, preferably contains a silanol compound, and further contains other components, if necessary.

### <Latent Curing Agent>

The latent curing agent contained in the curable composition is the latent curing agent of the present invention.

No particular limitation is imposed on the content of the latent curing agent in the curable composition, which may be appropriately selected in accordance with the intended purpose. The content of the latent curing agent is preferably 1 part by mass or greater and 70 parts by mass or less and more preferably 1 part by mass or greater and 50 parts by mass or less relative to 100 parts by mass of the epoxy resin. When the content of the latent curing agent is less than 1 part by mass, curability may degrade. When the content of the latent curing agent is greater than 70 parts by mass, resin properties (e.g., flexibility) of a cured product may degrade.

### <Epoxy Resin>

No particular limitation is imposed on the epoxy resin, which may be appropriately selected in accordance with the intended purpose. Examples of the epoxy compound include alicyclic epoxy resins, glycidyl ether-type epoxy resins, glycidyl ester-type epoxy resins, solvent-containing epoxy resins obtained by dissolving the foregoing in a solvent, and the like.

No particular limitation is imposed on the alicyclic epoxy resin, which may be appropriately selected in accordance with the intended purpose. Examples of the alicyclic epoxy resin include vinyl cyclopentadiene dioxide, vinyl cyclohexene mono- or di-oxide, dicyclopentadiene oxide, epoxy-[epoxy-oxaspiro C₈₋₁₅ alkyl]-cyclo C₅₋₁₂ alkane (e.g., 3,4-epoxy-1-[8,9-epoxy-2,4-dioxaspiro [5.5] undecan-3-yl]-cyclohexane and the like), 3,4-epoxycyclohexylmethyl-3′,4′-epoxycyclohexane carborate, epoxy C₅₋₁₂ cycloalkyl C₁₋₃ alkyl-epoxy C₅₋₁₂ cycloalkane carboxylate (e.g., 4,5-epoxycyclooctylmethyl-4′,5′-epoxycyclooctane carboxylate and the like), bis(C₁₋₃ alkyl-epoxy C₅₋₁₂ cycloalkyl C₁₋₃ alkyl)dicarboxylate (e.g., bis(2-methyl-3,4-epoxycyclohexylmethyl)adipate and the like), and the like. These may be used alone or in combination.

As the alicyclic epoxy resin, 3,4-epoxycyclohexylmethyl-3′,4′-epoxycyclohexane carboxylate (available from Daicel Corporation, product name: CELLOXIDE #2021P, epoxy equivalent: from 128 through 140) is suitable for use in terms of ease of procurement as a commercially available product.

In the listing of examples above, the descriptions C₈₋₁₅, C₅₋₁₂, and C₁₋₃ stand for the number of carbon atoms being from 8 through 15, the number of carbon atoms being from 5 through 12, and the number of carbon atoms being from 1 through 3, respectively, and suggest structural variations of the compounds.

The structural formula of an example of the alicyclic epoxy resin is presented below.

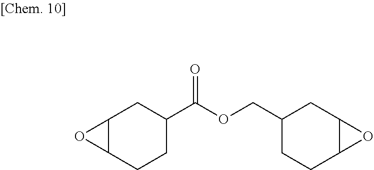 [SMILES: O=C(OCC1CCC2OC2C1)C1CCC2OC2C1]

The glycidyl ether-type epoxy resin or the glycidyl ester-type epoxy resin may be, for example, a liquid or a solid, typically has an epoxy equivalent of from about 100 through about 4,000, and preferably contains two or more epoxy groups in a molecule thereof. Examples thereof include bisphenol A-type epoxy resins, bisphenol F-type epoxy resins, phenol novolac-type epoxy resins, cresol novolac-type epoxy resins, phthalic acid ester-type epoxy resins, and the like. These may be used alone or in combination. Of these, bisphenol A-type epoxy resins are suitable for use in terms of resin properties. These epoxy resins encompass monomers and oligomers.

### <Silanol Compound>

Examples of the silanol compound include aryl silanol compounds and the like.

The aryl silanol compound is represented by, for example, general formula (A) below.

[Chem. 11]

(Ar)ₘSi(OH)ₙ General formula (A)

In general formula (A), m is 2 or 3 and is preferably 3, and the sum of m and n is 4. Ar is an aryl group that may contain a substituent.

The aryl silanol compound represented by general formula (A) is a monool form or a diol form.

In general formula (A), Ar is an aryl group that may contain a substituent.

Examples of the aryl group include a phenyl group, a naphthyl group (e.g., a 1-naphthyl group, a 2-naphthyl group, and the like), an anthracenyl group (e.g., a 1-anthracenyl group, a 2-anthracenyl group, a 9-anthracenyl group, a benz[a]-9-anthracenyl group, and the like), a phenaryl group (e.g., a 3-phenaryl group, a 9-phenaryl group, and the like), a pyrenyl group (e.g., a 1-pyrenyl group and the like), an azulenyl group, a fluorenyl group, a biphenyl group (e.g., a 2-biphenyl group, a 3-biphenyl group, a 4-biphenyl group, and the like), a thienyl group, a furyl group, a pyrrolyl group, an imidazolyl group, a pyridyl group, and the like. These may be used alone or in combination. Of these, a phenyl group is preferable in terms of ease of procurement and cost for procurement. The “m” number of Ar may be the same as or different from each other, but preferably are the same in terms of ease of procurement.

For example, these aryl groups may contain from 1 through 3 substituents.

Examples of the substituent include electron withdrawing groups, electron donating groups, and the like.

Examples of the electron withdrawing group include halogen groups (e.g., a chloro group, a bromo group, and the like), a trifluoromethyl group, a nitro group, a sulfo group, a carboxyl group, alkoxycarbonyl groups (e.g. a methoxycarbonyl group, an ethoxycarbonyl group, and the like), a formyl group, and the like.

Examples of the electron donating group include alkyl groups (e.g., a methyl group, an ethyl group, a propyl group, and the like), alkoxy groups (e.g., a methoxy group, an ethoxy group, and the like), a hydroxy group, an amino group, monoalkyl amino groups (e.g., a monomethyl amino group and the like), dialkyl amino groups (e.g., a dimethyl amino group and the like), and the like.

Specific examples of a phenyl group containing a substituent include a 2-methylphenyl group, a 3-methylphenyl group, a 4-methylphenyl group, a 2,6-dimethylphenyl group, a 3,5-dimethylphenyl group, a 2,4-dimethylphenyl group, a 2,3-diemthylphenyl group, a 2,5-dimethylphenyl group, a 3,4-dimethylphenyl group, a 2,4,6-trimethylphenyl group, a 2-ethylphenyl group, a 4-ethylphenyl group, and the like.

Use of an electron withdrawing group as a substituent makes it possible to increase the acidity of a hydroxyl group of a silanol group. Use of an electron donating group as a substituent makes it possible to decrease the acidity of a hydroxyl group of a silanol group. Therefore, with the substituent, it is possible to control the curing activity.

Here, the “m” number of Ar may contain different substituents, but preferably contain the same substituent in terms of ease of procurement regarding the “m” number of Ar. Moreover, some Ar may contain a substituent and the other Ar may contain no substituent.

Of these, triphenyl silanol and diphenyl silanediol are preferable, and triphenyl silanol is particularly preferable.

### <Other Components>

No particular limitation is imposed on the other components, which may be appropriately selected in accordance with the intended purpose. Examples of the other components include an oxetane compound, a silane coupling agent, a filler, a pigment, an antistat, and the like.

### <<Oxetane Compound>>

By using the oxetane compound in combination with the epoxy resin in the curable composition, it is possible to sharpen an exothermic peak.

Examples of the oxetane compound include 3-ethyl-3-hydroxymethyloxetane, 1,4-bis{[(3-ethyl-3-oxetanyl)methoxy]methyl}benzene, 4,4′-bis[(3-ethyl-3-oxetanyl)methoxymethyl]biphenyl, 1,4-benzenedicarboxylic acid bis[(3-ethyl-3-oxetanyl)]methyl ester, 3-ethyl-3-(phenoxymethyl)oxetane, 3-ethyl-3-(2-ethylhexyloxymethyl)oxetane, di[1-ethyl(3-oxetanyl)]methyl ether, 3-ethyl-3-{[3-(triethoxysilyl)propoxy]methyl}oxetane, oxetanylsilsesquioxane, phenol novolac oxetane, and the like. These may be used alone or in combination.

No particular limitation is imposed on the content of the oxetane compound in the curable composition, which may be appropriately selected in accordance with the intended purpose. However, the content of the oxetane compound is preferably 10 parts by mass or more and 100 parts by mass or less and more preferably 10 parts by mass or more and 50 parts by mass or less relative to 100 parts by mass of the epoxy resin.

### <<Silane Coupling Agent>>

As described in paragraphs [0007] to [0010] of Japanese Laid-Open Patent Application No. 2002-212537, the silane coupling agent has a function of cooperating with an aluminum chelate compound to initiate cationic polymerization of an epoxy resin. Hence, combined use of such a silane coupling agent in a small amount can provide an effect of promoting curing of an epoxy resin. Such a silane coupling agent contains from 1 through 3 lower alkoxy groups in a molecule thereof, and may contain a reactive group in a molecule thereof, such as a vinyl group, a styryl group, an acryloyloxy group, a methacryloyloxy group, an epoxy group, an amino group, a mercapto group, or the like. Because the latent curing agent of the present invention is a cationic curing agent, a coupling agent containing an amino group or a mercapto group may be used as long as the amino group or the mercapto group does not substantially trap cationic species generated.

Examples of the silane coupling agent include vinyl tris(β-methoxyethoxy)silane, vinyl triethoxysilane, vinyl trimethoxysilane, γ-styryl trimethoxysilane, γ-methacryloxypropyl trimethoxysilane, γ-acryloxypropyl trimethoxysilane, β-(3,4-epoxycyclohexyl)ethyl trimethoxysilane, γ-glycidoxypropyl trimethoxysilane, γ-glycidoxypropyl methyl diethoxysilane, N-β-(aminoethyl)-γ-aminopropyl trimethoxysilane, N-β-(aminoethyl)-γ-aminopropyl methyl dimethoxysilane, γ-aminopropyl triethoxysilane, N-phenyl-γ-aminopropyl trimethoxysilane, γ-mercaptopropyl trimethoxysilane, γ-chloropropyl trimethoxysilane, and the like. These may be used alone or in combination.

No particular limitation is imposed on the content of the silane coupling agent in the curable composition, which may be appropriately selected in accordance with the intended purpose. The content of the silane coupling agent is preferably 1 part by mass or greater and 300 parts by mass or less and more preferably 1 part by mass or greater and 100 parts by mass or less relative to 100 parts by mass of the cuing agent.

The curable composition of the present invention can be cured at a temperature lower than in existing compositions, has a significantly improved one-pack storage stability, and has a high convenience. Therefore, the curable composition of the present invention can be successfully used in various fields widely.

### EXAMPLES

The present invention will be described below by way of examples. However, the present invention should not be construed as being limited to these examples.

### Production Example 1 of Latent Curing Agent

### <Production of Catalyst Powder A>

### <<Porous Particle Producing Step>>

### -Preparation of Aqueous Phase-

Distilled water (800 parts by mass), a surfactant (NEWREX R-T, obtained from NOF Corporation) (0.05 parts by mass), polyvinyl alcohol (PVA-205, obtained from Kuraray Co., Ltd.) (4 parts by mass) serving as a dispersant were put in a 3-liter interfacial polymerization vessel equipped with a thermometer, and mixed uniformly, thereby preparing an aqueous phase.

### -Preparation of Oil Phase-

Next, a 24% by mass solution of aluminum monoacetyl acetonate bis(ethyl acetoacetate) in isopropanol (ALUMICHELATE D, obtained from Kawaken Fine Chemicals Co., Ltd.) (100 parts by mass), a trimethylolpropane (1 mole) adduct of methylene diphenyl-4,4′-diisocyanate (3 moles) (a multifunctional isocyanate compound, D-109, obtained from Mitsui Chemicals, Inc.) (70 parts by mass), divinylbenzene (obtained from Merck Corporation) (30 parts by mass) serving as a radical polymerizable compound, and a radical polymerization initiator (PEROYL L, obtained from NOF Corporation) in an amount equivalent to 1% by mass of the radical polymerizable compound (0.3 parts by mass) were dissolved in ethyl acetate (100 parts by mass), thereby preparing an oil phase.

### -Emulsification-

The prepared oil phase was fed into the aqueous phase prepared beforehand, and mixed and emulsified using a homogenizer (10,000 rpm/5 minutes, T-50, obtained from IKA Japan K.K.), thereby obtaining an emulsified liquid.

### -Polymerization-

The prepared emulsified liquid was subjected to interfacial polymerization and radical polymerization at 80° C. for 6 hours. After completion of reaction, the polymerization reaction liquid was allowed to cool to room temperature (25° C.). Produced polymerized particles were separated through filtration, and dried naturally at room temperature (25° C.), thereby obtaining a lumpy curing agent. The obtained lumpy curing agent was crushed to primary particles using a crusher (A-O JET MILL, obtained from Seishin Enterprise Co., Ltd.), thereby obtaining a particulate curing agent.

### -Highly Impregnating Treatment of Aluminum Chelate Compound-

The obtained particulate curing agent (15.0 parts by mass) was fed into an aluminum chelate-based solution [a solution obtained by dissolving an aluminum chelate compound (ALUMICHLATE D, obtained from Kawaken Fine Chemicals Co., Ltd.) (12.5 parts by mass) and another aluminum chelate compound (ALCH-TR), obtained from Kawaken Fine Chemicals, Co., Ltd.) (25.0 parts by mass) in ethyl acetate (62.5 parts by mass)], and stirred at 80° C. for 9 hours at a stirring speed of 200 rpm while evaporating ethyl acetate.

After completion of stirring, the resulting product was filtrated and washed with cyclohexane, thereby obtaining a lumpy curing agent. The obtained lumpy curing agent was subjected to vacuum drying at 30° C. for 4 hours, and subsequently crushed to primary particles using a crusher (A-O JET MILL, obtained from Seishin Enterprise Co., Ltd.), thereby obtaining 17.0 parts by mass of catalyst powder A (porous particles) that was highly impregnated with the aluminum chelate compound.

### Production Example 2 of Latent Curing Agent

### <Production of Catalyst Powder B; Low Temperature-Active Type>

Catalyst powder B (porous particles) was obtained in the same manner as in Production Example 1 of latent curing agent except that unlike in “Preparation of oil phase” in Production Example 1 of latent curing agent, divinylbenzene was changed to a bifunctional acrylate having a polyethylene glycol chain (LIGHT ACRYLATE 4EG-A, obtained from KYOEISHA CHEMICAL Co., LTD.).

### Production Example 3 of Catalyst Powder

### <Production of Catalyst Powder C; Type of Encapsulation of Both Low-Temperature Highly Active Aluminum Chelate Compound and Silanol Compound>

Distilled water (850 parts by mass), a surfactant (NEWREX R-T, obtained from NOF Corporation) (0.05 parts by mass), polyvinyl alcohol (PVA-205, obtained from Kuraray Co., Ltd.) (4 parts by mass) serving as a dispersant were put in a 3-liter interfacial polymerization vessel equipped with a thermometer, and mixed uniformly, thereby preparing an aqueous phase.

Separately, an oil phase was prepared by dissolving, in ethyl acetate (70 parts by mass), a 24% by mass solution of aluminum monoacetyl acetonate bis(ethyl acetoacetate) in isopropanol (ALUMICHELATE D, obtained from Kawaken Fine Chemicals Co., Ltd.) (20 parts by mass), a trimethylolpropane (1 mole) adduct of methylene diphenyl-4,4′-diisocyanate (3 moles) (D-109, obtained from Mitsui Chemicals Polyurethane, Inc.) (10 parts by mass), and triphenylsilanol (TPS, obtained from Tokyo Chemical Industry Co., Ltd.) (20 parts by mass). The prepared oil phase was charged to the above-prepared aqueous phase, followed by emulsifying and mixing in a homogenizer (10,000 rpm/5 min). Subsequently, the resulting mixture was allowed to undergo interfacial polymerization at 80° C. for 6 hours while distilling off ethyl acetate.

After completion of reaction, the polymerization reaction liquid was allowed to cool to room temperature, and the polymerized particles were separated through filtration and dried in air, thereby obtaining catalyst powder C (porous particles).

### Example 1

### <Preparation of High Latency-Imparting Treatment Solution>

APL6509T (COC resin, glass transition temperature (Tg): 80° C., obtained from Mitsui Chemicals Inc.) serving as the alicyclic polyolefin resin was dissolved in methylcyclohexane so as to be a concentration of 0.1% by mass. Subsequently, an isocyanate silane coupling agent (KBE-9007N, obtained from Shin-Etsu Chemical Co., Ltd.) was added thereto so as to be a concentration of 0.1% by mass and dissolved with ultrasonic waves, thereby preparing a high latency-imparting treatment solution.

### <Preparation of Spray Drying Treatment Liquid>

Catalyst powder B was ultrasonically dispersed in the high latency-imparting treatment solution at a concentration of 10% by mass, thereby preparing a spray drying treatment liquid.

### <Spray Drying Treatment>

A spray dryer (Mini Spray Dryer B-290, obtained from Nihon BUCHI K.K.) was used to perform spray drying (solvent removal) of the spray drying treatment liquid, thereby obtaining a coarsely-divided particulate curing agent. The inlet temperature of the drying chamber was set to 45° C. The obtained coarsely-divided particulate curing agent was crushed to primary particles using a crusher (A-O Jet Mill, obtained from SEISHIN ENTERPRISE Co., Ltd.), thereby obtaining a particulate curing agent. Through the above procedure, a latent curing agent of Example 1 was obtained.

### -Quantification of Alicyclic Polyolefin Resin-

The catalyst subjected to the high latency-imparting treatment was dispersed in chlorobenzene at a concentration of 25% by mass and stirred at 200 rpm at room temperature for 7 days, thereby dissolving the high-latent resin layer containing the alicyclic polyolefin resin. Subsequently, after removal of the catalyst particles by a treatment with a filter of 0.45 μm, the amount of the alicyclic polyolefin contained in the liquid recovered was measured using TG/DTA. The percentage of the COC resin of the latent curing agent of Example 1 was 0.24% by mass.

### -Concentration of Isocyanate Silane Coupling Agent-

When the concentration of the isocyanate silane coupling agent in the high latency-imparting treatment solution exceeded 0.5% by mass, poor crushing (stickiness) by the addition of liquid components was observed during crushing with a jet mill. Therefore, the concentration of the isocyanate silane coupling agent was set to 0.5% by mass or lower. The following shows the treatment results obtained when the concentration of the isocyanate silane coupling agent was 0.1% by mass.

### Example 2

A latent curing agent of Example 2 was obtained in the same manner as in Example 1 except that unlike in <Preparation of high latency-imparting treatment solution> in Example 1, APL6509T was changed to ARTON RX4500 (COP resin, Tg: 132° C., obtained from JSR Corporation).

### Example 3

A latent curing agent of Example 3 was obtained in the same manner as in Example 1 except that unlike in Example 1, catalyst powder B was changed to catalyst powder C, and the concentration of APL6509T in <Preparation of high latency-imparting treatment solution> was changed to 1.5% by mass.

### Example 4

A latent curing agent of Example 4 was obtained in the same manner as in Example 1 except that unlike in Example 1, catalyst powder B was changed to catalyst powder A.

### Example 5

A latent curing agent of Example 5 was obtained in the same manner as in Example 1 except that unlike in <Preparation of high latency-imparting treatment solution> in Example 1, APL6509T was changed to TAFMER XM-7070 (α-olefin copolymer, Tm: 75° C., obtained from Mitsui Chemicals Inc.).

### Comparative Example 1

A curing agent of Comparative Example 1 was obtained in the same manner as in Example 1 except that unlike in Example 1, catalyst powder B was changed to catalyst powder A, and catalyst powder A was not subjected to spray drying using the high latency-imparting treatment solution (catalyst powder A: untreated).

### Comparative Example 2

A curing agent of Comparative Example 2 was obtained in the same manner as in Example 1 except that unlike in Example 1, catalyst powder B was changed to catalyst powder A, and the isocyanate silane coupling agent (KBE-9007N, obtained from Shin-Etsu Chemical Co., Ltd.) was not added in

### <Preparation of High Latency-Imparting Treatment Solution>.

### Comparative Example 3

A curing agent of Comparative Example 3 was obtained in the same manner as in Example 1 except that unlike in Example 1, catalyst powder B was not subjected to spray drying using the high latency-imparting treatment solution (catalyst powder B: untreated).

### Comparative Example 4

A curing agent of Comparative Example 4 was obtained in the same manner as in Example 1 except that unlike in <Preparation of high latency-imparting treatment solution> in Example 1, the isocyanate silane coupling agent (KBE-9007N, obtained from Shin-Etsu Chemical Co., Ltd.) was not added.

### Comparative Example 5

A curing agent of Comparative Example 5 was obtained in the same manner as in Example 3 except that unlike in Example 3, spray drying using the high latency-imparting treatment solution was not performed (catalyst powder C: untreated).

### <DSC Measurement of Comparative Examples 1 and 2>

When catalyst powder A was used, even if no isocyanate silane coupling agent was used, sufficient high latency was exhibited.

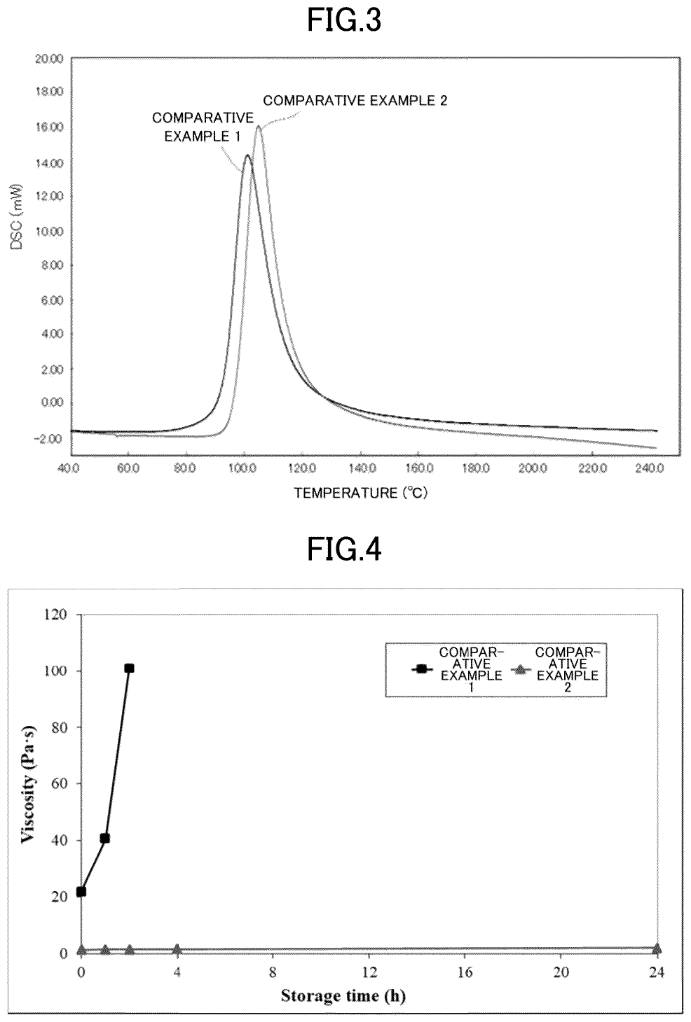

For the curing agents of Comparative Examples 1 and 2, DSC measurement was performed in the following manner. The results are shown in Table 1. The DSC charts of Comparative Examples 1 and 2 are shown in FIG. 3.

### -DSC Measurement Composition-

A composition prepared at a mass ratio of EP828:triphenyl silanol:latent curing agent=80:8:4 was used as a sample for DSC measurement.
EP828 (a bisphenol A-type epoxy resin, obtained from Mitsubishi Chemical Corporation)
Triphenyl silanol (obtained from Tokyo Chemical Industry Co., Ltd.)
Curing agent: the curing agent of Example 1 or Comparative Example 2

### -DSC Measurement Conditions-

Measuring instrument: DSC6200 (obtained from Hitachi High-Tech Science Corporation)
Amount for evaluation: 5 mg
Temperature elevation rate: 10° C./min

TABLE 1

| | High | Exothermic | Exothermic | Total quantity |
|---|---|---|---|---|
| | latency- | onset | peak | of generated |
| | imparting | temperature | temperature | heat |
| | treatment | (° C.) | (° C.) | (J/g) |
| Comparative | Before | 76.1 | 101.2 | −422 |
| Example 1 | treatment | | | |
| Comparative | After | 88.6 | 104.8 | −423 |
| Example 2 | treatment | | | |

From the results of FIG. 3 and Table 1, comparison between Comparative Examples 1 and 2 indicates that by performing the high latency-imparting treatment, the exothermic onset temperature is increased by 10° C. or higher.

### <Liquid Lifetime of Comparative Examples 1 and 2 Under Storage at Room Temperature (25° C.)>

Next, the curing agents of Comparative Examples 1 and 2 were evaluated for one-pack storage stability in accordance with viscosity change in the following manner. The results are shown in Table 2. The viscosity changes of Comparative Examples 1 and 2 are shown in FIG. 4.

### -Storage Stability Measuring Composition-

A composition prepared at a mass ratio of EP807:CEL2021P:KBM-403:triphenylsilanol:curing agent=50:50:0.5:7:2 was used as a sample for storage stability measurement.
EP807 (a bisphenol F-type epoxy resin, obtained from Mitsubishi Chemical Corporation)
CEL2021P (an alicyclic epoxy resin, obtained from Daicel Corporation)
KBM-403 (a silane coupling agent, obtained from Shin-Etsu Chemical Co., Ltd.)
Triphenylsilanol (obtained from Tokyo Chemical Industry Co., Ltd.)
Curing agent: the curing agent of Comparative Example 1 or 2

### -Storage Stability Conditions-

Storage temperature: 25° C.
Storage time: 24 hours
Viscosity measurement: SV-100 (Tuning-fork vibration-type viscometer, obtained from A&D Company, Limited)
Measurement temperature: 20° C.

TABLE 2

| | | | | | | | Factor of |
|---|---|---|---|---|---|---|---|
| | | | | | | | increase in |
| | High | | | After | After | After | viscosity |
| | latency- | | After | 2 | 4 | 24 | after 24 |
| | imparting | Initial | 1 hour | hours | hours | hours | hours |
| | treatment | (Pa · s) | (Pa · s) | (Pa · s) | (Pa · s) | (Pa · s) | (Factor) |
| Comparative | Before | 21.8 | 40.6 | 100.9 | Not | | — |
| Example 1 | treatment | | | | measurable | | |
| Comparative | After | 1.3 | 1.5 | 1.5 | 1.5 | 2.1 | 1.6 |
| Example 2 | treatment | | | | | | |

From the results of Table 2 and FIG. 4, for Comparative Example 1 in which the high latency-imparting treatment was not performed, thickening of the measurement liquid was observed from the beginning of the measurement, and the measurement was impossible to continue after 4 hours of storage at room temperature due to highly thickening. Meanwhile, for Comparative Example 2 in which the high latency-imparting treatment was performed, favorable one-pack storage stability is exhibited. A factor of increase in viscosity after 24 hours of the product being subjected to the high latency-imparting treatment was less than two compared to the initial viscosity.

### <DSC Measurement of Comparative Examples 3 and 4>

In the same manner as in Comparative Examples 1 and 2, DSC measurement was performed on the curing agents of Comparative Examples 3 and 4 using the low-temperature active catalyst, which was prepared using the bifunctional acrylate having the polyethylene glycol chain. The results are shown in Table 3. The DSC charts of Comparative Examples 3 and 4 are shown in FIG. 5.

TABLE 3

| | | | | Total |
|---|---|---|---|---|
| | High | Exothermic | Exothermic | quantity of |
| | latency- | onset | peak | generated |
| | imparting | temperature | temperature | heat |
| | treatment | (° C.) | (° C.) | (J/g) |
| Comparative | Before | 71.8 | 89.3 | −424 |
| Example 3 | treatment | | | |
| Comparative | After | 71.9 | 89.2 | −432 |
| Example 4 | treatment | | | |

From the results of FIG. 5 and Table 3, comparison between Comparative Examples 3 and 4 indicates no change in DSC charts when catalyst powder B exhibiting low-temperature activity was subjected to the high latency-imparting treatment.

### <Liquid Lifetime of Comparative Examples 3 and 4 Under Storage at Room Temperature (25° C.)>

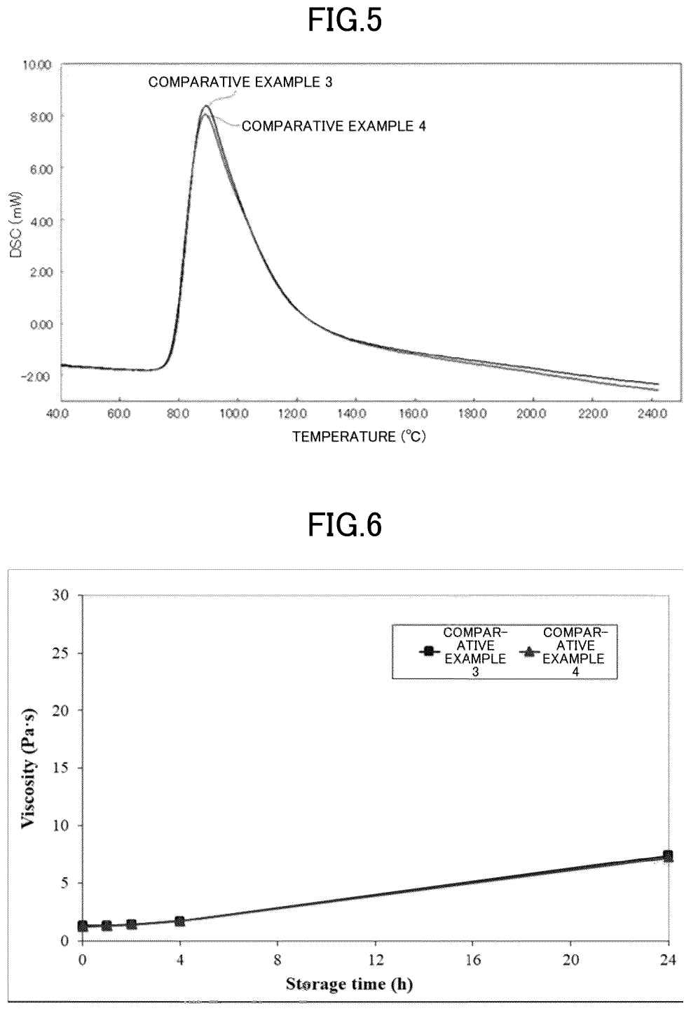

In the same manner as in Comparative Examples 1 and 2, the curing agents of Comparative Examples 3 and 4 were evaluated for one-pack storage stability in accordance with viscosity change. The results are shown in Table 4. The viscosity changes of Comparative Examples 3 and 4 are shown in FIG. 6.

TABLE 4

| | | | | | | | Factor of |
|---|---|---|---|---|---|---|---|
| | | | | | | | increase in |
| | High | | After | After | After | After | viscosity |
| | latency- | | 1 | 2 | 4 | 24 | after 24 |
| | imparting | Initial | hour | hours | hours | hours | hours |
| | treatment | (Pa · s) | (Pa · s) | (Pa · s) | (Pa · s) | (Pa · s) | (Factor) |
| Comparative | Before | 1.3 | 1.3 | 1.4 | 1.7 | 7.4 | 5.7 |
| Example 3 | treatment | | | | | | |
| Comparative | After | 1.3 | 1.3 | 1.4 | 1.7 | 7.2 | 5.5 |
| Example 4 | treatment | | | | | | |

From the results of Table 4 and FIG. 6, compared to Comparative Example 3 in which the high latency-imparting treatment was not performed, Comparative Example 4 in which the high latency-imparting treatment was performed is not increased in latency.

In relation to a cause for this, surface roughness (irregularities) of the catalyst particle surface was analyzed by an atomic force microscope (AFM) and the results are shown below.

### <Analysis of Surface Irregularities of Catalyst Powder a and Catalyst Powder B>

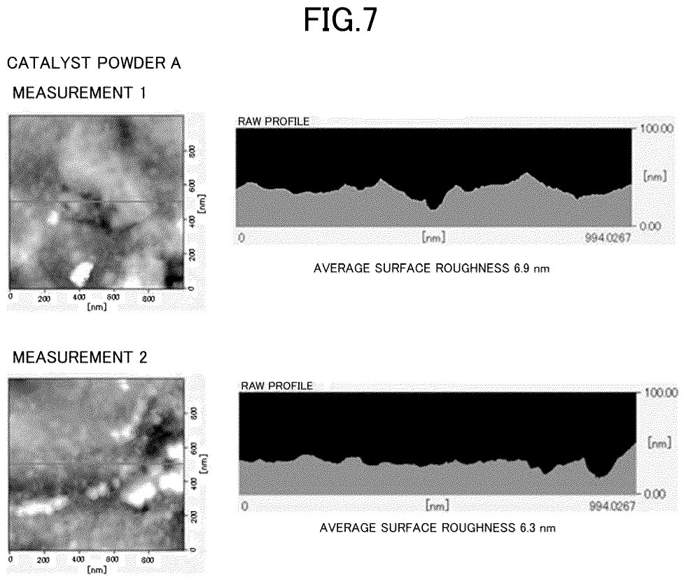

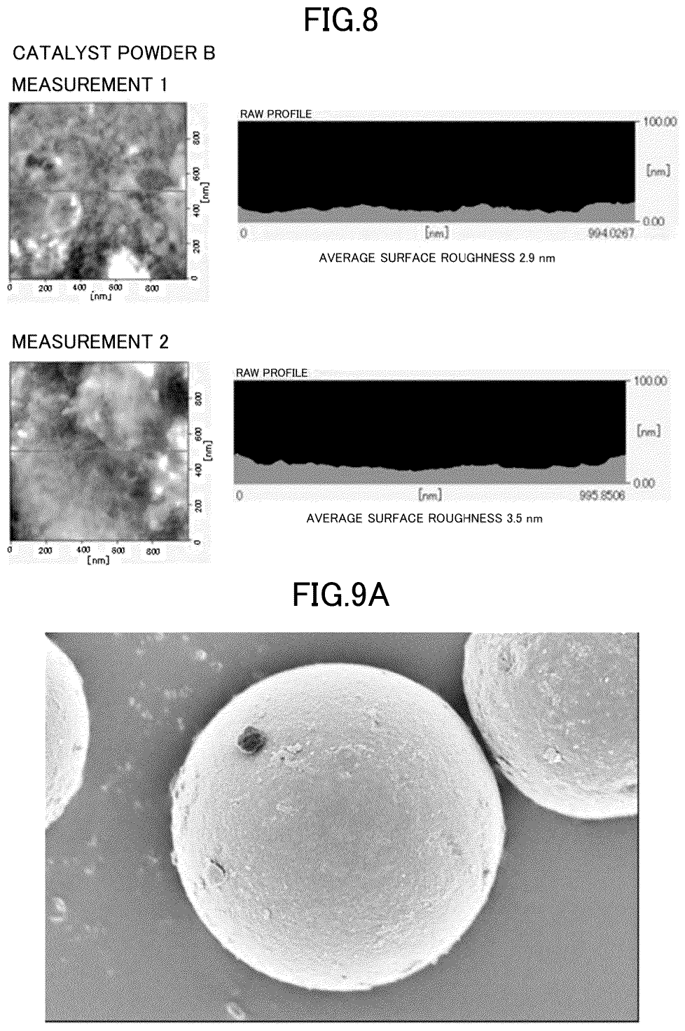

The COC, an alicyclic polyolefin resin, is a material intrinsically having poor attachability and poor adhesiveness. It is however considered that when the surface of the catalyst particle is rough, the attachability increases by virtue of the anchoring effect. The AFM measurement results of catalyst powder A and catalyst powder B are shown in FIG. 7 and FIG. 8.

### -Measurement of Average Surface Roughness by AFM-

AFM (SPA400, Hitachi High-Tech Corporation)

The AFM measurement results as illustrated in FIG. 7 and FIG. 8 indicate that the average surface roughness of catalyst powder A is from about 6 nm through about 7 nm and the average surface roughness of catalyst powder B is about 3 nm, i.e., catalyst powder A has a rougher surface.

### <SEM (Scanning Electron Microscope) Observation of Catalyst Powder a and Catalyst Powder B>

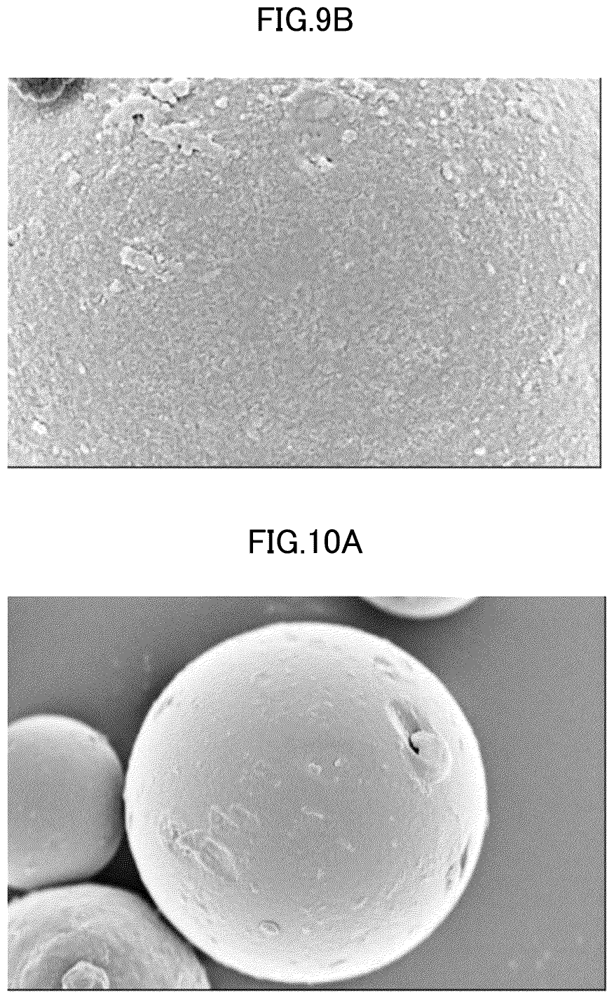

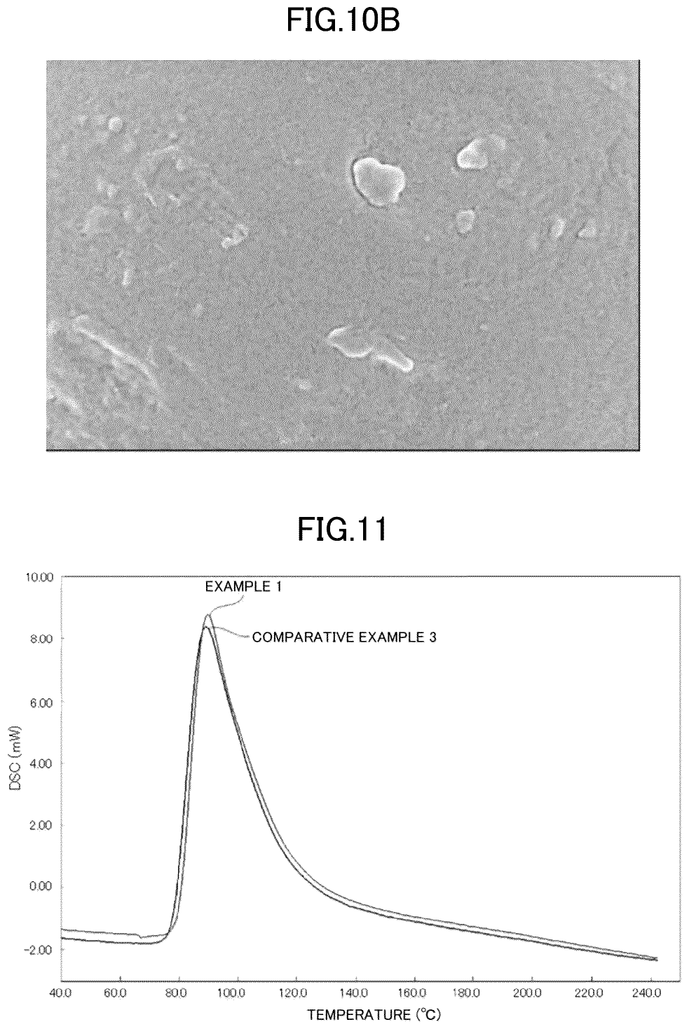

Next, SEM images of catalyst powder A and catalyst powder B taken with Helios G5UC (obtained from Thermo Fisher Scientific) are shown. FIG. 9A is an SEM image of catalyst powder A taken at a magnification of 35,000, and FIG. 9B is an SEM image of catalyst powder A taken at a magnification of 100,000. FIG. 10A is an SEM image of catalyst powder B taken at a magnification of 25,000, and FIG. 10B is an SEM image of catalyst powder B taken at a magnification of 100,000.

These SEM images indicate that the surface irregularities are lesser in catalyst powder B. Therefore, it was considered that the COC coating was not successfully formed in the treatment of catalyst powder B, and the high-latent effect was not able to be obtained.

Next, the following shows the results obtained when catalyst powder B was treated using an isocyanate silane coupling agent (IS) together with an alicyclic polyolefin resin.

### <DSC Measurement of Example 1 and Comparative Example 3>

In the same manner as in Comparative Examples 1 and 2, DSC measurement was performed on the curing agents of Example 1 and Comparative Example 3 using the COC as the alicyclic polyolefin resin. The results are shown in Table 5. The DSC charts of Example 1 and Comparative Example 3 are shown in FIG. 11.

TABLE 5

| | | | | Total |
|---|---|---|---|---|
| | High | Exothermic | Exothermic | quantity of |
| | latency- | onset | peak | generated |
| | imparting | temperature | temperature | heat |
| | treatment | (° C.) | (° C.) | (J/g) |
| Comparative | Before | 71.8 | 89.3 | −424 |
| Example 3 | treatment | | | |
| Example 1 | After | 73.6 | 89.9 | −415 |
| | treatment | | | |

The results of FIG. 11 and Table 5 confirmed that the exothermic onset temperature was increased by about 2° C. by the addition of the isocyanate silane coupling agent (IS). Also, no change in the exothermic peak temperature caused by the high latency-imparting treatment was observed.

### <DSC Measurement of Example 2 and Comparative Example 3>

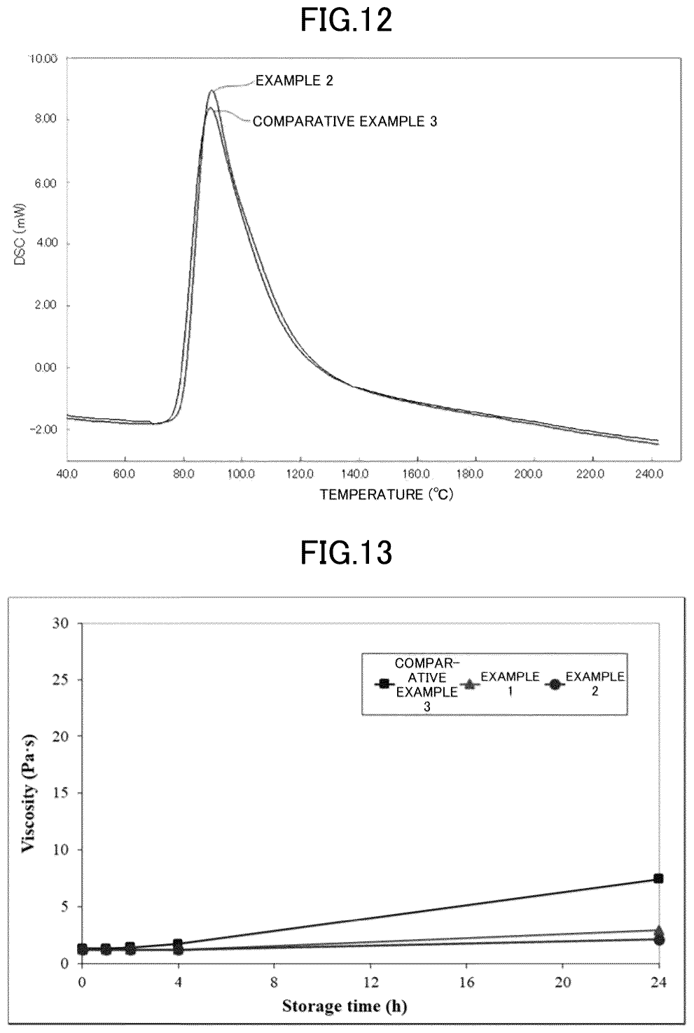

In the same manner as in Comparative Examples 1 and 2, DSC measurement was performed on the curing agents of Example 2 and Comparative Example 3 using the COP as the alicyclic polyolefin resin. The results are shown in Table 6. The DSC charts of Example 2 and Comparative Example 3 are shown in FIG. 12.

TABLE 6

| | | | | Total |
|---|---|---|---|---|
| | High | Exothermic | Exothermic | quantity of |
| | latency- | onset | peak | generated |
| | imparting | temperature | temperature | heat |
| | treatment | (° C.) | (° C.) | (J/g) |
| Comparative | Before | 71.8 | 89.3 | −424 |
| Example 3 | treatment | | | |
| Example 2 | After | 75.1 | 89.8 | −431 |
| | treatment | | | |

The results of FIG. 12 and Table 6 confirmed that the exothermic onset temperature was increased by about 3° C. by the addition of the isocyanate silane coupling agent (IS). Also, no change in the exothermic peak temperature caused by the high latency-imparting treatment was observed.

### <Liquid Lifetime of Examples 1 and 2 and Comparative Example 3 Under Storage at Room Temperature (25° C.)>

In the same manner as in Comparative Examples 1 and 2, the curing agents of Examples 1 and 2 and Comparative Example 3 were evaluated for one-pack storage stability in accordance with viscosity change. The results are shown in Table 7. The viscosity changes of Examples 1 and 2 and Comparative Example 3 are shown in FIG. 13.

TABLE 7

| | | | | | | | Factor of |
|---|---|---|---|---|---|---|---|
| | | | | | | | increase in |
| | High | | After | After | After | After | viscosity |
| | latency- | | 1 | 2 | 4 | 24 | after 24 |
| | imparting | Initial | hour | hours | hours | hours | hours |
| | treatment | (Pa · s) | (Pa · s) | (Pa · s) | (Pa · s) | (Pa · s) | (Factor) |
| Comparative | Before | 1.3 | 1.3 | 1.4 | 1.7 | 7.4 | 5.7 |
| Example 3 | treatment | | | | | | |
| Example 1 | After | 1.2 | 1.2 | 1.2 | 1.2 | 2.9 | 2.4 |
| | treatment | | | | | | |
| Example 2 | After | 1.2 | 1.2 | 1.2 | 1.2 | 2.1 | 1.8 |
| | treatment | | | | | | |

The results of Table 7 and FIG. 13 indicate that the surface irregularities are lesser by using the high latency-imparting treatment solution containing the isocyanate silane coupling agent (IS) in addition to the alicyclic polyolefin resin, and that even the low-temperature active catalyst powder B can be prepared as high-latent catalyst particles exhibiting favorable one-pack storage stability. In both of Examples 1 and 2, no thickening after 4-hour leaving at room temperature was observed. Also, a factor of increase in thickening after 24-hour leaving was suppressed to about two.

<Particle Size Distribution of Examples 1 and 2 and Comparative Example 3 (after Crushing)>

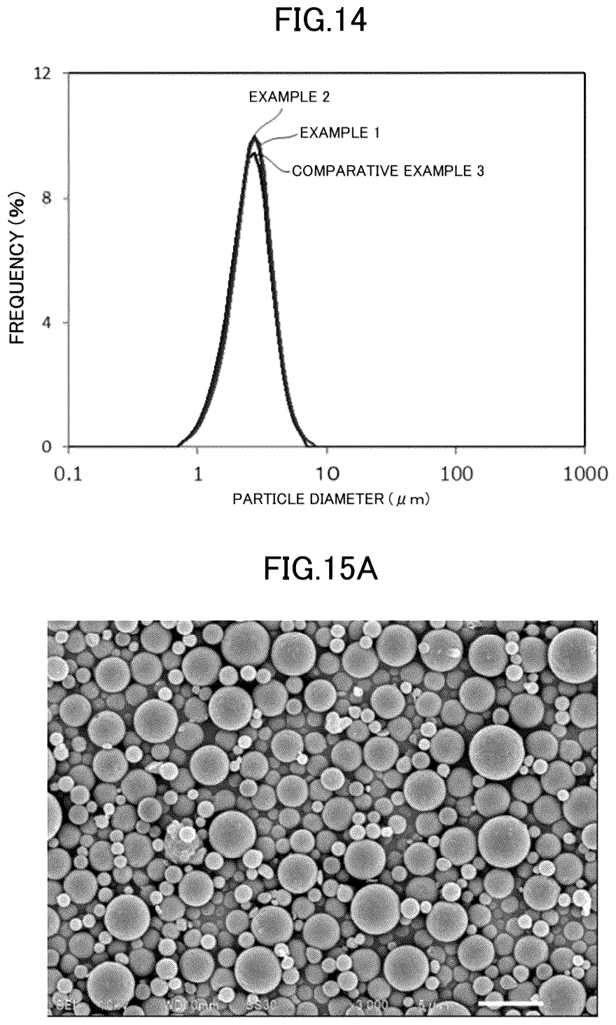

The curing agents of Examples 1 and 2 and Comparative Example 3 were measured for volume-based particle size distribution using MT3300EXII (laser diffraction and scattering, MicrotrackBEL Co., Ltd.). The results are shown in Table 8 and FIG. 14.

TABLE 8

| | | Volume | Maximum | |
|---|---|---|---|---|
| | High | average | volume | |
| | latency- | particle | particle | |
| | imparting | diameter | diameter | CV |
| | treatment | (μm) | (μm) | (%) |
| Comparative | Before | 2.6 | 7.8 | 35.7 |
| Example 3 | treatment | | | |
| Example 1 | After | 2.7 | 7.8 | 34.4 |
| | treatment | | | |
| Example 2 | After | 2.6 | 6.5 | 34.5 |
| | treatment | | | |

The results of Table 8 and FIG. 14 indicate that Examples 1 and 2, in which the high latency-imparting treatment was performed, show a state of primary particles after crushing.

### <SEM (Scanning Electron Microscope) Observation of Examples 1 and 2>

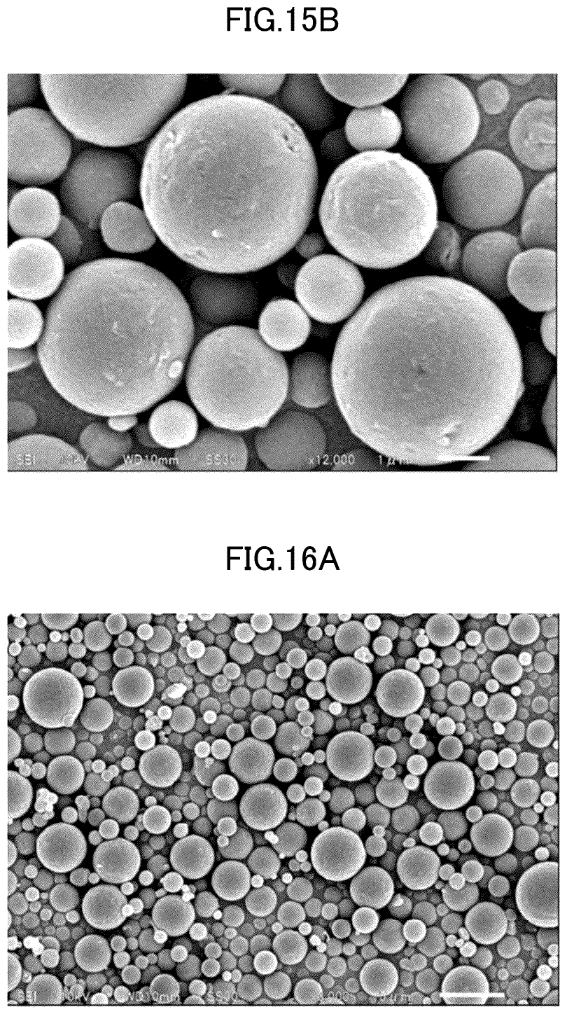

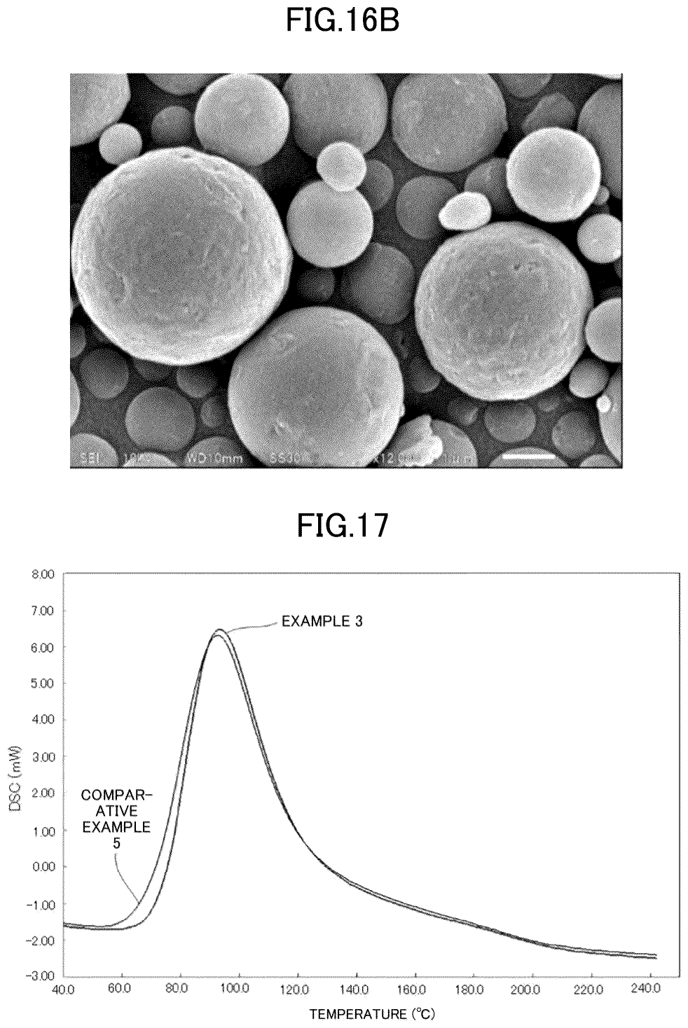

Next, SEM images of Examples 1 and 2 taken with JSM-6510A (obtained from JEOL Ltd.) are shown. FIG. 15A is an SEM image of the latent curing agent of Example 1 taken at a magnification of 3,000. FIG. 15B is an SEM image of the latent curing agent of Example 1 at a magnification of 12,000. FIG. 16A is an SEM image of the latent curing agent of Example 2 taken at a magnification of 3,000. FIG. 16A is an SEM image of the latent curing agent of Example 2 taken at a magnification of 12,000.

The results of FIG. 15A, FIG. 15B, FIG. 16A, and FIG. 16B indicate that the latent curing agents of Examples 1 and 2 do not form aggregates or bulks, showing a favorable state of primary particles even after the high latency-imparting treatment.

The following shows the results of Example 3 in which catalyst powder C, low-temperature highly active catalyst powder, was treated in a system containing the alicyclic polyolefin resin and the IS.

### <DSC Measurement of Example 3 and Comparative Example 5>

In the same manner as in Comparative Examples 1 and 2, DSC measurement was performed on the curing agents of Example 3 and Comparative Example 5 using catalyst powder C and the COC as the alicyclic polyolefin resin. Because catalyst powder C is low-temperature highly active catalyst powder, the concentration of the COC was set to 1.5% by mass. The results are shown in Table 9. The DSC charts of Example 3 and Comparative Example 5 are shown in FIG. 17.

TABLE 9

| | | | | Total |
|---|---|---|---|---|
| | High | Exothermic | Exothermic | quantity of |
| | latency- | onset | peak | generated |
| | imparting | temperature | temperature | heat |
| | treatment | (° C.) | (° C.) | (J/g) |
| Comparative | Before | 55.5 | 92.8 | −442 |
| Example 5 | treatment | | | |
| Example 3 | After | 60.3 | 93.5 | −434 |
| | treatment | | | |

The results of FIG. 17 and Table 9 confirmed that when catalyst powder C, low-temperature highly active catalyst powder, was used and treated in the system containing the COC and the isocyanate silane coupling agent (IS), the exothermic onset temperature was increased by about 5° C. In the same manner as in Examples 1 and 2, the exothermic peak temperature was not appreciably changed by the high latency-imparting treatment.

### <Liquid Lifetime of Example 3 and Comparative Example 5 Under Storage at Room Temperature (25° C.)>

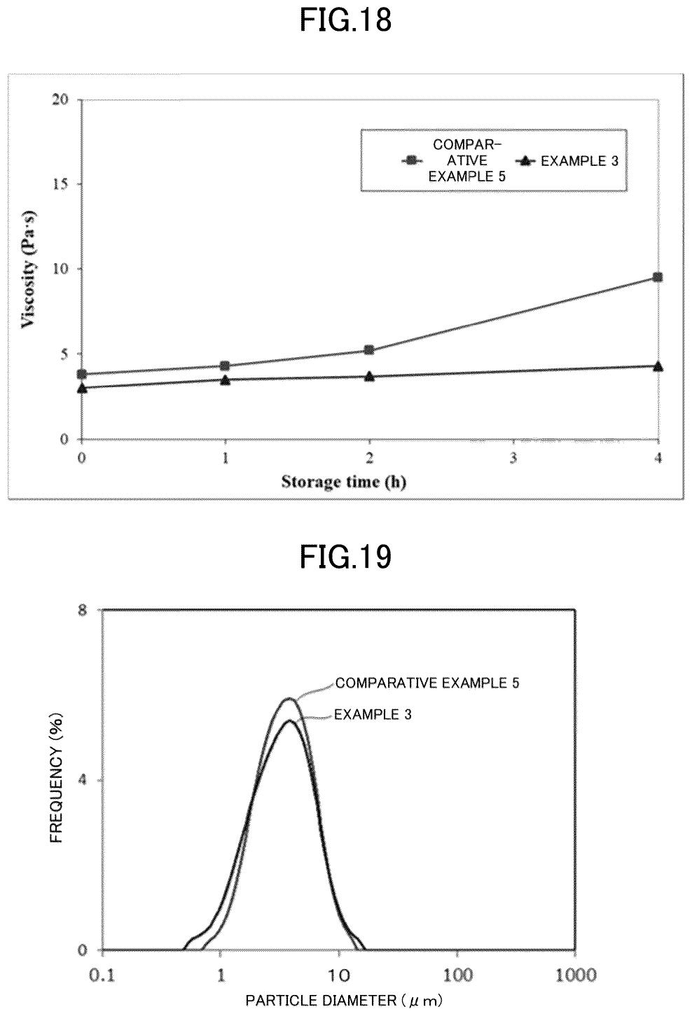

In the same manner as in Comparative Examples 1 and 2 except for the epoxy resin composition, the curing agents of Example 3 and Comparative Example 5 were evaluated for one-pack storage stability in accordance with viscosity change. The results are shown in Table 10. The viscosity changes of Example 3 and Comparative Example 5 are shown in FIG. 18.

### -Storage Stability Measuring Composition-

A composition prepared at a mass ratio of EP807:KBM-403:triphenylsilanol:curing agent=100:0.5:7:2 was used as a sample for storage stability measurement.
EP807 (a bisphenol F-type epoxy resin, obtained from Mitsubishi Chemical Corporation)
KBM-403 (a silane coupling agent, obtained from Shin-Etsu Chemical Co., Ltd.)
Triphenylsilanol (obtained from Tokyo Chemical Industry Co., Ltd.)
Curing agent: the curing agent of Example 3 or Comparative Example 5

TABLE 10

| | | | | | | Factor of |
|---|---|---|---|---|---|---|
| | | | | | | increase |
| | | | | | | in |
| | High | | After | After | After | viscosity |
| | latency- | | 1 | 2 | 4 | after 4 |
| | imparting | Initial | hour | hours | hours | hours |
| | treatment | (Pa · s) | (Pa · s) | (Pa · s) | (Pa · s) | (Factor) |
| Comparative | Before | 3.8 | 4.3 | 5.2 | 9.5 | 2.5 |
| Example 5 | treatment | | | | | |
| Example 3 | After | 3.0 | 3.5 | 3.7 | 4.3 | 1.4 |
| | treatment | | | | | |

The results of Table 10 and FIG. 18 indicate that by subjecting catalyst powder C, low-temperature highly active catalyst powder whose exothermic onset temperature upon DSC measurement is low, to the high latency-imparting treatment using a solution obtained by mixing and solving the COC and the IS, one-pack storage stability thereof in the epoxy resin is increased. The untreated product exhibited 2.5 as the factor of increase in viscosity after 4-hour storage at room temperature, but the treated product exhibited less than 1.5 as the factor of increase in viscosity after 4-hour storage at room temperature.

<Particle Size Distribution of Example 3 and Comparative Example 5 (after Crushing)>

The curing agents of Example 3 and Comparative Example 5 were measured for volume-based particle size distribution using MT3300EXII (laser diffraction and scattering, MicrotrackBEL Co., Ltd.). The results are shown in Table 11 and FIG. 19.

TABLE 11

| | | Volume | Maximum | |
|---|---|---|---|---|
| | High | average | volume | |
| | latency- | particle | particle | |
| | imparting | diameter | diameter | CV |
| | treatment | (μm) | (μm) | (%) |
| Comparative | Before | 3.8 | 13.1 | 50.7 |
| Example 5 | treatment | | | |
| Example 3 | After | 3.7 | 15.6 | 55.7 |
| | treatment | | | |

The results of Table 11 and FIG. 19 indicate that Comparative Example 5 and Example 3 are approximately the same in the value of the volume average particle diameter before and after the treatment, showing that the particle size is not greatly changed even after crushing following the high latency-imparting treatment, i.e., showing the state of primary particles.

### <SEM (Scanning Electron Microscope) Observation of Example 3>

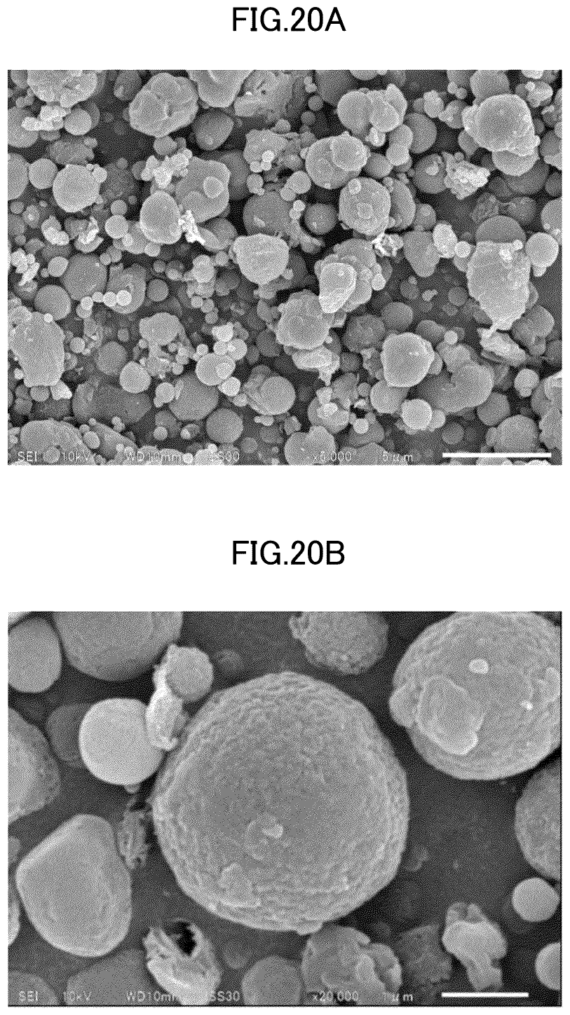

Next, an SEM image of Example 3 taken with JSM-6510A (obtained from JEOL Ltd.) is shown. FIG. 20A is an SEM image of the latent curing agent of Example 3 taken at a magnification of 5,000. FIG. 20B is an SEM image of the latent curing agent of Example 3 taken at a magnification of 20,000.

The results of FIG. 20A and FIG. 20B confirmed a state in which the high-latent resin layer covers the surface of the catalyst powder.

### <Quantification of High-Latent Resin Layers of Examples 1 and 3>

First, the COC resin (APL6509T, glass transition temperature Tg: 80° C., obtained from Mitsui Chemicals Inc.) was measured for TG under the following conditions. As a result, it was confirmed that the weight thereof decreased by about 92% from 400° C. through 500° C.

### -TG Measurement Conditions-

TG/DTA6200 (obtained from Hitachi High-Tech Science Corporation)
Heating rate: 10° C./min
Measured weight: 5 mg

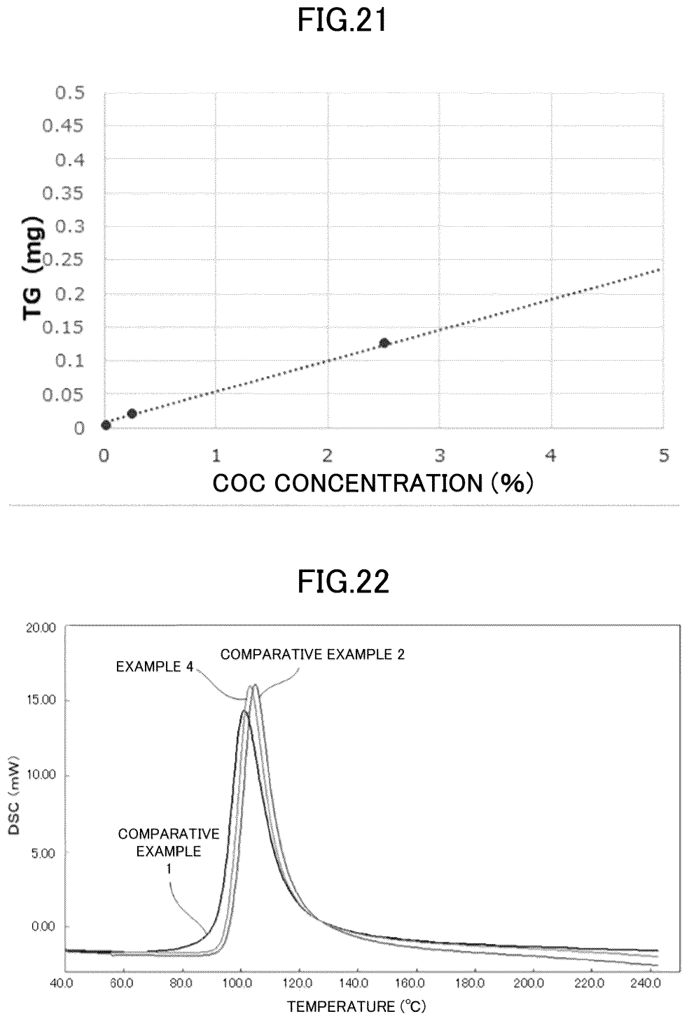

A correlation graph between the COC resin concentration and TG (mg) measured by applying this is illustrated in FIG. 21. For the measurement, a solution obtained by dissolving the COC resin in chlorobenzene was used. Values of weight loss in the range of from 400° C. through 500° C. are plotted as the TG.

### <Quantification of COC Content of Catalyst Subjected to High Latency-Imparting Treatment>

From the measured values of TG/DTA, the COC concentration in the measurement liquid was calculated using the above COC concentration-TG correlation graph. Subsequently, the percentage of the COC resin contained in the catalyst was calculated from the amount of the treated catalyst and the amount of the liquid. The results are shown in Table 12.

TABLE 12

| | Concentration | | | |
|---|---|---|---|---|
| | of COC resin | | | |
| | in high | | | Percentage |
| | latency- | | | of COC |
| | imparting | | Concentration | resin in |
| | treatment | TG* | of COC resin | catalyst |
| | (% by mass) | (mg) | (% by mass) | (% by mass) |
| Example 1 | 0.1 | 0.004 | 0.09 | 0.24 |
| Example 3 | 1.5 | 0.035 | 0.76 | 2.11 |

*TG* (mg) in Table 12 indicates the amount of weight loss in the range of from 400° C. through 500° C.

The results of Table 12 indicate that the percentage of the COC resin of the latent curing agent of Example 1 is 0.24% by mass, and the percentage of the COC resin of the curing agent of Example 3 is 2.11% by mass, confirming that the high-latent resin covered the surface of the catalyst particle in the state of a thin layer.

### <Surface Elemental Analysis by XPS of Examples 1 and 2 and Comparative Example 3>

Surface elemental analysis by XPS was performed on the curing agents of Examples 1 and 2 and Comparative Example 3 under the following conditions. The results are shown in Table 13.

### —XPS Measurement Conditions-

XPS (PHI 5000 Versa ProbeIII, obtained from ULVAC-PHI, INCORPORATED) was used as a measurement apparatus. AlKα was used as an X-ray source, and a current value of 34 mA, an acceleration voltage value of 15 kV, and a scan speed of 1 eV were used as measurement conditions.

TABLE 13

| | | High | | | | | | |
|---|---|---|---|---|---|---|---|---|
| | | latency- | | Atomic compositional ratio | | | | |
| | | imparting | | (atomic %) | | | | |
| | | treatment | n | C | N | O | Al | Si |
| Comparative | — | Not | 1 | 58.64 | 2.19 | 34.67 | 4.49 | 0.00 |
| Example 3 | | treated | 2 | 59.93 | 1.50 | 33.96 | 4.61 | 0.00 |
| | | | Avg. | 59.29 | 1.85 | 34.32 | 4.55 | 0.00 |
| Example 1 | COC + IS | After | 1 | 63.78 | 1.67 | 28.85 | 3.57 | 2.12 |
| | | treatment | 2 | 63.51 | 1.73 | 29.00 | 3.41 | 2.35 |
| | | | Avg. | 63.65 | 1.70 | 28.93 | 3.49 | 2.24 |
| Example 2 | COP + IS | After | 1 | 65.94 | 1.54 | 27.28 | 3.14 | 2.10 |
| | | treatment | 2 | 65.12 | 1.26 | 28.14 | 3.15 | 2.34 |
| | | | Avg. | 65.53 | 1.40 | 27.71 | 3.15 | 2.22 |

The results of Table 13 confirmed that carbon (C) on the surface of the catalyst particles tends to increase and aluminum (Al) on the surface of the catalyst particles tends to decrease in Examples 1 and 2, which are products subjected to the high latency-imparting treatment. This suggests formation of a high-latent resin layer on the surface of the catalyst particles. Also, in the products subjected to the high latency-imparting treatment, Si derived from the IS is detected on the surface of the catalyst particles.

### <Surface Elemental Analysis by XPS of Example 3 and Comparative Example 5>

In the same manner as in Examples 1 and 2 and Comparative Example 3, surface elemental analysis by XPS was performed on the curing agents of Example 3 and Comparative Example 5. The results are shown in Table 14.

TABLE 14

| | | High | | | | | | |
|---|---|---|---|---|---|---|---|---|
| | | latency- | | Atomic compositional ratio | | | | |
| | | imparting | | (atomic %) | | | | |
| | | treatment | n | C | N | O | Al | Si |
| Comparative | — | Not | 1 | 71.03 | 0.02 | 22.11 | 3.03 | 3.81 |
| Example 5 | | treated | 2 | 71.35 | 0.01 | 21.60 | 3.20 | 3.84 |
| | | | Avg. | 71.19 | 0.02 | 21.86 | 3.12 | 3.83 |
| Example 3 | COC + IS | After | 1 | 86.71 | 0.01 | 9.43 | 0.74 | 3.12 |
| | | treatment | 2 | 86.73 | 0.01 | 9.10 | 0.85 | 3.31 |
| | | | Avg. | 86.72 | 0.01 | 9.27 | 0.80 | 3.22 |

The results of Table 14 indicate that similarly in Example 3, carbon (C) on the surface of the catalyst particles tends to increase and aluminum (Al) on the surface of the catalyst particles tends to decrease after the high latency-imparting treatment. Also, it can be considered that because the concentration of the alicyclic polyolefin resin used for the treatment is higher in Example 3, the increase rate of C and the reduction rate of Al become somewhat higher than those of Examples 1 and 2.

### <DSC Measurement of Example 4 and Comparative Examples 1 and 2>

In the same manner as in Comparative Examples 1 and 2, DSC measurement was performed on Example 4 using catalyst powder A and, for comparison, on the curing agent before treatment (catalyst powder; Comparative Example 1) and the curing agent of Comparative Example 2 treated without addition of the isocyanate silane coupling agent (IS). The results are shown in Table 15. The DSC charts of Example 4 and Comparative Examples 1 and 2 are shown in FIG. 22.

TABLE 15

| | | | | | Total |
|---|---|---|---|---|---|
| | High | | Exothermic | Exothermic | quantity of |
| | latency- | | onset | peak | generated |
| | imparting | Addition | temperature | temperature | heat |
| | treatment | of IS | (° C.) | (° C.) | (J/g) |
| Comparative | Before | — | 76.1 | 101.2 | −422 |
| Example 1 | treatment | | | | |
| Comparative | After | Not | 88.6 | 104.8 | −423 |
| Example 2 | treatment | added | | | |
| Example 4 | After | Added | 86.3 | 103.1 | −417 |
| | treatment | | | | |

The results of FIG. 22 and Table 15 indicate that, similar to Comparative Example 2 treated only with the COC, the curing agent of Example 4 treated with the isocyanate silane coupling agent (IS) together with the COC exhibits a higher DSC onset temperature than that before treatment (Comparative Example 1). An increase in the onset temperature was about 10° C. Compared to Comparative Example 2 treated only with the COC, an increase in the DSC onset temperature and an increase in the peak temperature can be suppressed. This is likely because a more uniform coating is formed in Example 4 treated by the addition of the IS.

### <Liquid Lifetime of Example 4 and Comparative Examples 1 and 2 Under Storage at Room Temperature (25° C.)>

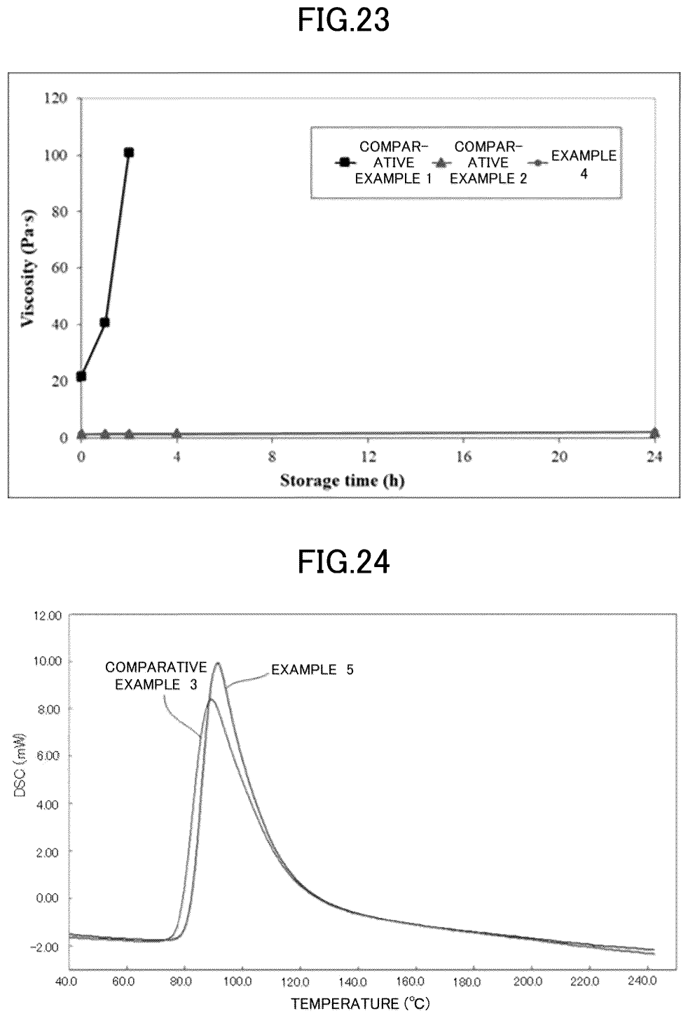

In the same manner as in Comparative Examples 1 and 2, the curing agents of Example 4 and Comparative Examples 1 and 2 were evaluated for one-pack storage stability in accordance with viscosity change. The results are shown in Table 16. The viscosity changes of Example 4 and Comparative Examples 1 and 2 are shown in FIG. 23.

TABLE 16

| | | | | | | | | Factor of |
|---|---|---|---|---|---|---|---|---|
| | | | | | | | | increase in |
| | High | | | After | Affer | After | After | viscosity |
| | latency- | | | 1 | 2 | 4 | 24 | after 24 |
| | imparting | Addition | Initial | hour | hours | hours | hours | hours |
| | treatment | of IS | (Pa · s) | (Pa · s) | (Pa · s) | (Pa · s) | (Pa · s) | (Factor) |
| Comparative | Before | — | 21.8 | 40.6 | 100.9 | Not | | — |
| Example 1 | treatment | | | | | measurable | | |
| Comparative | After | Not | 1.3 | 1.5 | 1.5 | 1.5 | 2.1 | 1.6 |
| Example 2 | treatment | added | | | | | | |
| Example 4 | After | Added | 1.3 | 1.3 | 1.3 | 1.3 | 2.0 | 1.5 |
| | treatment | | | | | | | |

The results of Table 16 and FIG. 23 confirmed favorable high latency regardless of addition of the IS for catalyst powder A. Especially, in Example 4 in which the isocyanate silane coupling agent (IS) was added, liquid stability involving approximately no thickening was shown after 4-hour storage at room temperature after preparation.

### <DSC Measurement of Example 5 and Comparative Example 3>

In the same manner as in Comparative Examples 1 and 2, DSC measurement was performed on the curing agents of Example 5 and Comparative Example 3. The results are shown in Table 17. The DSC charts of Example 5 and Comparative Example 3 are shown in FIG. 24.

TABLE 17

| | | | | Total |
|---|---|---|---|---|
| | High | Exothermic | Exothermic | quantity of |
| | latency- | onset | peak | generated |
| | imparting | temperature | temperature | heat |
| | treatment | (° C.) | (° C.) | (J/g) |
| Comparative | Before | 71.8 | 89.3 | −424 |
| Example 3 | treatment | | | |
| Example 5 | After | 74.3 | 91.5 | −408 |
| | treatment | | | |

The results of FIG. 24 and Table 17 indicate that, in Example 5, an increase in the exothermic onset temperature before and after the high latency-imparting treatment and an increase in the exothermic peak temperature can be suppressed to be lower than +3° C. This is because the polyolefin concentration in the treatment was low, and the α-olefin copolymer exhibiting a low melting point was used.

### <Liquid Lifetime of Example 5 and Comparative Example 3 Under Storage at Room Temperature (25° C.)>

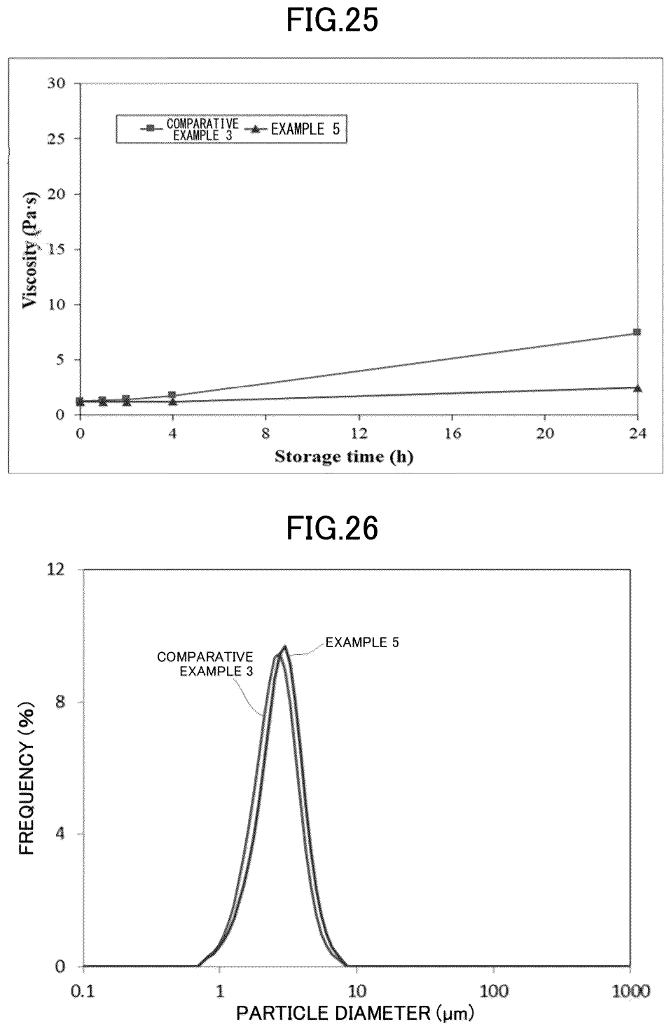

In the same manner as in Comparative Examples 1 and 2, the curing agents of Example 5 and Comparative Example 3 were evaluated for one-pack storage stability in accordance with viscosity change. The results are shown in Table 18. The viscosity changes of Example 5 and Comparative Example 3 are shown in FIG. 25.

TABLE 18

| | | | | | | | Factor of |
|---|---|---|---|---|---|---|---|
| | | | | | | | increase in |
| | High | | After | After | After | After | viscosity |
| | latency- | | 1 | 2 | 4 | 24 | after 24 |
| | imparting | Initial | hour | hours | hours | hours | hours |
| | treatment | (Pa · s) | (Pa · s) | (Pa · s) | (Pa · s) | (Pa · s) | (Factor) |
| Comparative | Before | 1.3 | 1.3 | 1.4 | 1.7 | 7.4 | 5.7 |
| Example 3 | treatment | | | | | | |
| Example 5 | After | 1.2 | 1.2 | 1.2 | 1.2 | 2.5 | 2.1 |
| | treatment | | | | | | |

The results of Table 18 and FIG. 25 indicate that Example 5, in which the high latency-imparting treatment was performed using the α-olefin copolymer, can form high-latent catalyst particles exhibiting favorable one-pack storage stability. Similar to Examples 1 and 2, no thickening after 4-hour leaving at room temperature was observed in Example 5. Also, a factor of increase in thickening after 24-hour leaving could be suppressed to about two.

<Particle Size Distribution of Example 5 and Comparative Example 3 (after Crushing)>

The curing agents of Example 5 and Comparative Example 3 were measured for volume-based particle size distribution using MT3300EXII (laser diffraction and scattering, MicrotrackBEL Co., Ltd.). The results are shown in Table 19 and FIG. 26.

TABLE 19

| | | Volume | Maximum | |
|---|---|---|---|---|
| | High | average | volume | |
| | latency- | particle | particle | |
| | imparting | diameter | diameter | CV |
| | treatment | (μm) | (μm) | (%) |
| Comparative | Before | 2.6 | 7.8 | 35.7 |
| Example 3 | treatment | | | |
| Example 5 | After | 2.8 | 7.8 | 35.7 |
| | treatment | | | |

The results of Table 19 and FIG. 26 indicate that Example 5, in which the high latency-imparting treatment was performed using the α-olefin copolymer, shows a state of primary particles after crushing.

### <SEM (Scanning Electron Microscope) Observation of Example 5>

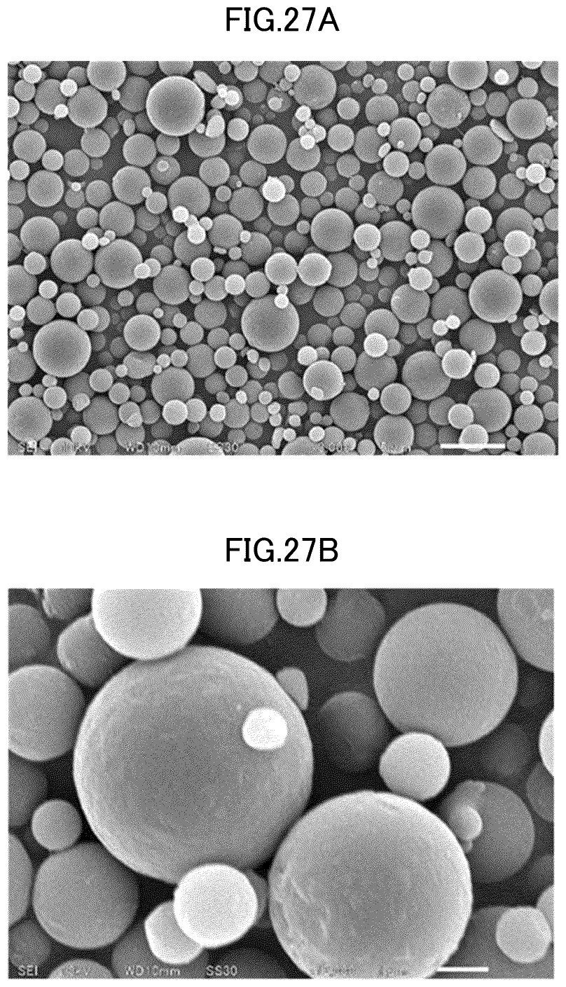

Next, an SEM image of Example 5 taken with JSM-6510A (obtained from JEOL Ltd.) is shown. FIG. 27A is an SEM image of the latent curing agent of Example 5 taken at a magnification of 3,000. FIG. 27B is an SEM image of the latent curing agent of Example 5 taken at a magnification of 12,000.

The results of FIG. 27A and FIG. 27B indicate that in Example 5, in which the high latency-imparting treatment was performed using the α-olefin copolymer, no formation of aggregates or bulks is observed, and a favorable state of primary particles is shown even after the high latency-imparting treatment.

As described above, the latent curing agent including: the porous particles retaining the aluminum chelate compound; and the coating on the surface of the porous particles, the coating containing the polyolefin resin, and the silane coupling agent having the isocyanate group can be cured at a temperature lower than before. Also, by containing this latent curing agent, it is possible to obtain an epoxy resin composition that is greatly improved in one-pack storage stability.

Further, the latent curing agent using the α-olefin copolymer instead of the alicyclic polyolefin resin can have high latency. The α-olefin copolymer has a melting point lower than that of the polyurea resin. Thus, a coating containing the α-olefin copolymer can be formed on the surface of the polyurea-based porous particles without inhibiting thermal responsiveness of the polyurea-based porous particles.

The present international application claims priority to Japanese Patent Application No. 2021-192704 filed on Nov. 29, 2021 and Japanese Patent Application No. 2022-122430 filed on Aug. 1, 2022, and the entire contents of Japanese Patent Application No. 2021-192704 and Japanese Patent Application No. 2022-122430 are incorporated in the present international application by reference.

1. A latent curing agent, comprising:
porous particles retaining an aluminum chelate compound; and
a coating on a surface of the porous particles, the coating containing a polyolefin resin, and a silane coupling agent having an isocyanate group.

2. The latent curing agent as claimed in claim 1, wherein
an average surface roughness of the porous particles is 5 nm or less.

3. The latent curing agent as claimed in claim 1, wherein
the polyolefin resin is an alicyclic polyolefin resin, an α-olefin copolymer, or both.

4. The latent curing agent as claimed in claim 3, wherein
a glass transition temperature of the alicyclic polyolefin resin is 140° C. or lower.

5. The latent curing agent as claimed in claim 3, wherein
the alicyclic polyolefin resin is a cycloolefin copolymer (COC), a cycloolefin homopolymer (COP), or both.

6. The latent curing agent as claimed in claim 3, wherein
the α-olefin copolymer has a melting point of 100° C. or lower.

7. The latent curing agent as claimed in claim 1, wherein
the porous particles include a polyurea resin.

8. The latent curing agent as claimed in claim 7, wherein
the porous particles further include
a polymerized product of a radical-polymerizable monomer having a long-chain structure.

9. The latent curing agent as claimed in claim 1, wherein
the porous particles retain a silanol compound.

10. A production method for a latent curing agent, the production method comprising:
spray-drying a dispersion liquid obtained by dispersing porous particles retaining an aluminum chelate compound in a treatment liquid, the treatment liquid containing a polyolefin resin and a silane coupling agent having an isocyanate group in an organic solvent.

11. The production method for the latent curing agent as claimed in claim 10, wherein
an average surface roughness of the porous particles is 5 nm or less.

12. The production method for the latent curing agent as claimed in claim 10, wherein
a content of the polyolefin resin in the treatment liquid is 1.5% by mass or less.

13. The production method for the latent curing agent as claimed in claim 10, wherein
a content of the silane coupling agent having the isocyanate group in the treatment liquid is 0.5% by mass or less.

14. A curable composition, comprising:
the latent curing agent of claim 1; and
a cationically curable compound.

15. The curable composition as claimed in claim 14, wherein
the cationically curable compound is an epoxy compound or an oxetane compound.

16. The curable composition as claimed in claim 14, further comprising:
a silanol compound.

17. The latent curing agent as claimed in claim 2, wherein
the polyolefin resin is an alicyclic polyolefin resin, an α-olefin copolymer, or both.

18. The latent curing agent as claimed in claim 2, wherein
the porous particles include a polyurea resin.

19. The latent curing agent as claimed in claim 2, wherein
the porous particles retain a silanol compound.
